(19) United States
(12) Patent Application Publication
(10) Pub. No.: US 2026/0288172 A1
(43) Pub. Date: Sep. 24, 2026

(54) METHOD AND CONTROL SYSTEM FOR CONTROLLING A FOLLOWER GROUND ROBOT FOR TRACKING A LEADER GROUND ROBOT

(71) Applicant: NANYANG TECHNOLOGICAL UNIVERSITY, Singapore (SG)

(72) Inventors: Guoqiang HU, Singapore (SG); Renhe GUAN, Singapore (SG)

(21) Appl. No.: 19/472,617

(22) PCT Filed: Apr. 3, 2024
(86) PCT No.: PCT/SG2024/050222

§ 371 Date: Oct. 3, 2025

(30) Foreign Application Priority Data
Apr. 4, 2023 (SG) 10202300924Q

(51) Int. Cl. G05D 1/695; G05D 1/633; G06T 7/246; G06T 7/50; G06T 7/73

(52) U.S. Cl. CPC G05D 1/695; G05D 1/633; G06T 7/246; G06T 7/50; G06T 7/73; G06T 2207/10024; G06T 2207/10028; G06T 2207/30261

(57) ABSTRACT

A method of controlling a follower ground robot for tracking a leader ground robot as a leader-follower pair is provided. The follower ground robot includes a mobile platform configured to travel on a ground and a depth sensor configured to be rotatable with respect to the mobile platform for rotating a sensing direction. The method includes: obtaining a current color image and associated depth information of a scene captured by the depth sensor; determining a scene point set based on the current color image and the associated depth information; obtaining pixel coordinates of the leader ground robot in the current color image; determining a sensing direction control input for controlling, by rotating the depth sensor, a sensing direction of the depth sensor based on the scene point set; determining a navigation control input for controlling a movement of the mobile platform based on the pixel coordinates of the leader ground robot and the scene point set; and controlling the sensing direction of the depth sensor and the movement of the mobile platform based on the sensing direction control input and the navigation control input, respectively, for tracking the leader ground robot and maintaining the leader ground robot within a field of view of the depth sensor. There is also provided a corresponding control system and a corresponding mobile ground robot including the control system.

### CROSS-REFERENCE TO RELATED APPLICATION

This application is a 371 National Stage of International Application No. PCT/SG2024/050222, filed on 3 Apr. 2024, which claims the benefit of priority of Singapore Patent Application No. 10202300924Q filed on 4 Apr. 2023, the content of which being hereby incorporated by reference in its entirety for all purposes.

### TECHNICAL FIELD

The present invention generally relates to vision-based leader-follower formation tracking control of mobile robots, and more particularly, relates to a method of controlling a follower ground robot for tracking a leader ground robot as a leader-follower pair and a control system thereof, especially in an environment or area with obstacles.

### BACKGROUND

Recently, leader-follower formation tracking control of mobile robots has attracted significant attention from many researchers and engineers owing to its high efficiency, broad range of practical applications, ease of implementation and scalability, such as surveillance, mapping and rescue after disasters. For example, in many logistics factories, leader-follower formation tracking may be employed for cooperative transportation and sorting of goods. These mobile robots typically use a wireless communication network system, such as a global positioning system, installed inside the factory to obtain their global positions and relative positions to other mobile robots for enabling leader-follower formation tracking control to perform collaborative tasks. In addition, a panoramic LiDAR (Light Detection and Ranging) sensors are often installed on these mobile robots (which may be referred to as cooperative warehouse logistics mobile robots) for detecting and avoiding obstacles. However, such conventional techniques rely on global positioning systems and LiDAR sensors, which significantly increase cost and limit the size of the workspace. As another example, to achieve leader-follower formation tracking control of mobile robots in obstacle environments without data communication therebetween (e.g., directly or via a wireless communication network system) and prior maps, conventional techniques typically require the follower mobile robot to be equipped with at least a camera to recognize the leader and a panoramic LiDAR sensor to observe obstacles. However, using such two sensors is more expensive, takes up additional space and requires additional calibration between sensors than a single sensor, which may thus be not conducive or practical to real-world applications. Accordingly, despite the large amount of related research work, there has not yet been developed a method for leader-follower formation tracking control that is cost effective and practical to implement, for enabling a wider range of practical applications.

A need therefore exists to provide a method of controlling a follower ground robot for tracking a leader ground robot as a leader-follower pair, and a control system thereof, that seeks to overcome, or at least ameliorate, one or more deficiencies in conventional methods of leader-follower formation tracking control, and more particularly, to provide a leader-follower formation tracking control with enhanced or improved cost effectiveness and practicality, especially in an environment or area with obstacles, for enabling a wider range of practical applications. It is against this background that the present invention has been developed.

### SUMMARY

According to a first aspect of the present invention, there is provided a method of controlling a follower ground robot for tracking a leader ground robot as a leader-follower pair, the follower ground robot comprising a mobile platform configured to travel on a ground and a depth sensor configured to be rotatable with respect to the mobile platform for rotating a sensing direction, the method comprising:
obtaining a current color image and associated depth information of a scene captured by the depth sensor;
determining a scene point set based on the current color image and the associated depth information, the scene point set comprising a plurality of scene points, each scene point corresponding to a pixel point of the current color image and has associated therewith a relative distance and a relative angle between the follower ground robot and a scene portion at the pixel point of the current color image;
obtaining pixel coordinates of the leader ground robot in the current color image;
determining a sensing direction control input for controlling, by rotating the depth sensor, a sensing direction of the depth sensor based on the scene point set;
determining a navigation control input for controlling a movement of the mobile platform based on the pixel coordinates of the leader ground robot and the scene point set; and
controlling the sensing direction of the depth sensor and the movement of the mobile platform based on the sensing direction control input and the navigation control input, respectively, for tracking the leader ground robot and maintaining the leader ground robot within a field of view of the depth sensor.

According to a second aspect of the present invention, there is provided a control system for controlling a follower ground robot for tracking a leader ground robot as a leader-follower pair, the follower ground robot comprising a mobile platform configured to travel on a ground and a depth sensor configured to be rotatable with respect to the mobile platform for rotating a sensing direction, the control system comprising:
at least one memory; and
at least one processor communicatively coupled to the at least one memory and configured to:
obtain a current color image and associated depth information of a scene captured by the depth sensor;
determine a scene point set based on the current color image and the associated depth information, the scene point set comprising a plurality of scene points, each scene point corresponding to a pixel point of the current color image and has associated therewith a relative distance and a relative angle between the follower ground robot and a scene portion at the pixel point of the current color image;
obtain pixel coordinates of the leader ground robot in the current color image;
determine a sensing direction control input for controlling, by rotating the depth sensor, a sensing direction of the depth sensor based on the scene point set;
determine a navigation control input for controlling a movement of the mobile platform based on the pixel coordinates of the leader ground robot and the scene point set; and
control the sensing direction of the depth sensor and the movement of the mobile platform based on the sensing direction control input and the navigation control input, respectively, for tracking the leader ground robot and maintaining the leader ground robot within a field of view of the depth sensor.

According to a third aspect of the present invention, there is provided a computer program product, embodied in one or more non-transitory computer-readable storage mediums, comprising instructions executable by at least one processor to perform the method of controlling a follower ground robot for tracking a leader ground robot according to the above-mentioned first aspect of the present invention.

According to a fourth aspect of the present invention, there is a mobile ground robot comprising:
a mobile platform configured to travel on a ground;
a depth sensor configured to be rotatable with respect to the mobile platform for rotating a sensing direction; and
the control system according to the above-mentioned second aspect of the present invention communicatively coupled to the mobile platform and the depth sensor for controlling the mobile ground robot as a follower ground robot for tracking a leader ground robot as a leader-follower pair.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic flow diagram of a method of controlling a follower ground robot for tracking a leader ground robot as a leader-follower pair, according to various embodiments of the present invention;

FIG. 2 depicts a schematic block diagram of a control system for controlling a follower ground robot for tracking a leader ground robot as a leader-follower pair, according to various embodiments of the present invention;

FIG. 3 depicts a schematic drawing of a mobile ground robot, according to various embodiments of the present invention;

FIGS. 4A to 4C illustrate three technical problems for leader-follower formation tracking control of mobile robots using a RGB-D camera with a limited FOV;

FIG. 5 illustrates a mobile robot formation divided into a number of leader-follower robot pairs;

FIG. 6 depicts a schematic drawing illustrating a relationship between a pair of leader-follower robots, according to various example embodiments of the present invention;

FIG. 7 depicts a vertical view schematic of the leader-follower formation, according to various example embodiments of the present invention;

FIG. 8 depicts a schematic flow diagram of an example leader-follower formation tracking control method, according to various example embodiments of the present invention;

FIG. 9 depicts a schematic drawing illustrating a workspace associated with the follower robot, according to various example embodiments of the present invention;

FIG. 10 depicts a schematic drawing illustrating a number of example factors considered by the follower robot when performing the camera rotation method, according to various example embodiments of the present invention;

FIG. 11 depicts a schematic flow diagram of an example camera rotation method, according to various example embodiments of the present invention;

FIG. 12 depicts a schematic flow diagram of an example method of constructing a scene point set Θ_{f}, according to various example embodiments of the present invention;

FIG. 13 depicts a schematic flow diagram of an example method of determining the navigation control input for navigating the follower robot for tracking the leader robot, according to various example embodiments of the present invention;

FIG. 14 shows an example method (or an algorithm referred to herein as Algorithm 1) for constructing a scene point set Θ_{f}, according to various example embodiments of the present invention;

FIG. 15 shows an example method (or an algorithm referred to herein as Algorithm 2) for determining the navigation control input for navigating the follower robot for tracking the leader robot in an obstacle environment, according to various example embodiments of the present invention;

FIG. 16 shows an environment map illustrating trajectories and topology of robot, according to various example embodiments of the present invention;

FIG. 17 shows plots of the relative positions x_{lf} and y_{lf} among robots, according to various example embodiments of the present invention;

FIG. 18 shows plots of the camera rotation angle φ_{c} and the closest obstacle distance d_{fo}, according to various example embodiments of the present invention;

FIG. 19 shows plots of the environment exploration rate eᵢ and the relative angle α_{lf} to the leader, according to various example embodiments of the present invention;

FIG. 20 illustrates robot formation in an experiment and a rotatable camera mounted on a follower, according to various example embodiments of the present invention;

FIG. 21 shows plots of normalized pixel coordinates (p, q) and image pixels (u, v) of a target feature of the leader, where the dotted lines represent desired values;

FIG. 22 shows plots of relative distance and angle to the nearest obstacle, as well as the exploration rate eᵢ and the camera rotation angle φ_{c}; and

FIG. 23 shows robot formation between a follower and a leader in the presence of a moving human.

### DETAILED DESCRIPTION

Various embodiments of the present invention relate to vision-based leader-follower formation tracking control of mobile robots, and more particularly, provide a method of controlling a follower ground robot for tracking a leader ground robot as a leader-follower pair and a control system thereof, especially in an environment or area with obstacles.

As explained in the background, to achieve leader-follower formation tracking control of mobile robots in obstacle environments without data communication therebetween (e.g., directly or via a wireless communication network system) and prior maps, conventional techniques typically require the follower mobile ground robot to be equipped with at least a camera for detecting the leader ground robot and a panoramic LiDAR sensor to detect obstacles. However, using such two sensors is more expensive, takes up additional space and requires additional calibration between sensors than a single sensor, which may thus be not conducive or practical to real-world applications. Accordingly, despite the large amount of related research work, there has not yet been developed a method for leader-follower formation tracking control that is cost effective and practical to implement, for enabling a wider range of practical applications. In this regard, various embodiments of the present invention provide a method of controlling a follower ground robot for tracking a leader ground robot as a leader-follower pair, and a control system thereof, that seeks to overcome, or at least ameliorate, one or more deficiencies in conventional methods of leader-follower formation tracking control, and more particularly, to provide a leader-follower formation tracking control with enhanced or improved cost effectiveness and practicality, especially in an environment or area with obstacles, for enabling a wider range of practical applications.

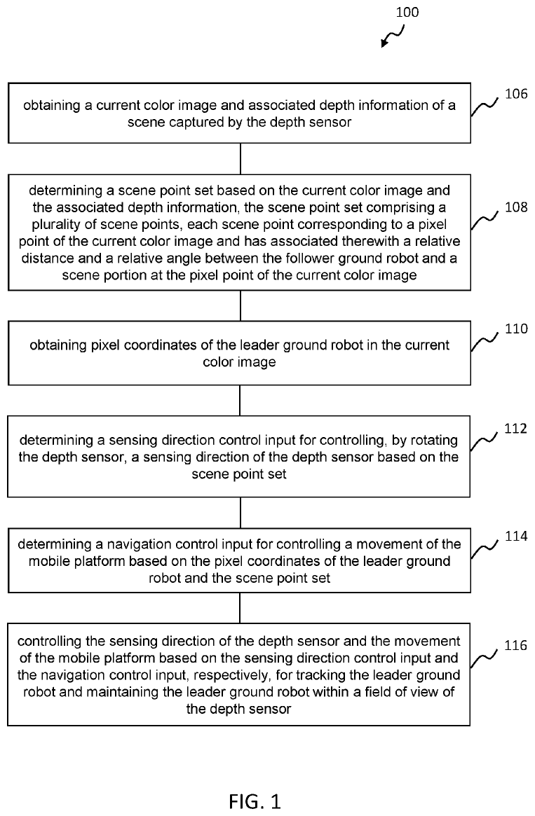

FIG. 1 depicts a schematic flow diagram of a method 100 of controlling a follower ground robot for tracking a leader ground robot as a leader-follower pair, according to various embodiments of the present invention. The follower ground robot comprises a mobile platform configured to travel on a ground and a depth sensor configured to be rotatable with respect to the mobile platform for rotating a sensing direction. The method 100 comprises: obtaining (at 106) a current color image and associated depth information of a scene captured by the depth sensor; determining (at 108) a scene point set based on the current color image and the associated depth information, the scene point set comprising a plurality of scene points, each scene point corresponding to a pixel point of the current color image and has associated therewith a relative distance and a relative angle between the follower ground robot and a scene portion at the pixel point of the current color image; obtaining (at 110) pixel coordinates of the leader ground robot in the current color image; determining (at 112) a sensing direction control input for controlling, by rotating the depth sensor, a sensing direction of the depth sensor based on the scene point set; determining (at 114) a navigation control input for controlling a movement of the mobile platform based on the pixel coordinates of the leader ground robot and the scene point set; and controlling (at 116) the sensing direction of the depth sensor and the movement of the mobile platform based on the sensing direction control input and the navigation control input, respectively, for tracking the leader ground robot and maintaining the leader ground robot within a field of view of the depth sensor.

In various embodiments, the above-mentioned determining (at 108) the scene point set comprises, for each pixel point of the current color image: determining a corresponding position of the scene portion at the pixel point in a current frame of the follower ground robot based on the depth information associated with the pixel point of the current colour image; and adding a scene point in the scene point set corresponding to the position of the scene portion at the pixel point in the current frame of the follower ground robot, the scene point having associated therewith the relative distance and the relative angle between the follower ground robot and the scene portion at the pixel point of the current color image. Accordingly, a number of scene points in the scene point set may correspond to obstacle points, each obstacle point corresponding to a pixel point capturing an obstacle portion of an obstacle thereat. Therefore, in various embodiments, the scene point set may also be referred to as an obstacle set as it includes obstacle points.

In various embodiments, the sensor direction control input is determined based on a leader tracking factor function and an area exploration factor function. In this regard, the leader tracking factor function is configured to output a leader tracking factor value dependent on a sensor direction variable, the leader tracking factor value providing a measure of tracking of the leader ground robot with respect to the field of view of the depth sensor for a sensor direction. The area exploration factor function is configured to output an area exploration factor value dependent on the sensor direction variable, the area exploration factor value providing a measure of a degree of sensor obstacle exploration of an area associated with a sensor direction.

In various embodiments, the sensor direction control input is determined further based on a dynamic obstacle tracking factor function and a large (or sharp) sensor rotation avoidance factor function. In this regard, the dynamic obstacle tracking factor function configured to output a dynamic obstacle tracking factor value dependent on the sensor direction variable, the dynamic obstacle tracking factor value providing a measure of tracking of one or more moving obstacles with respect to the field of view of the depth sensor for a sensor direction. The large sensor rotation avoidance factor function configured to output a large (or sharp) sensor rotation avoidance factor value dependent on the sensor direction variable, the large sensor rotation avoidance factor value providing a measure of a degree of sensor rotation for a sensor direction. In this regard, the large sensor rotation avoidance factor value may be computed based on a difference between the sensor direction variable and the sensor direction at the last (immediately previous) sampling instant, and thus, the sensor direction variable may be optimized using the large sensor rotation avoidance factor function for minimizing the above-mentioned difference between the sensor direction variable and the sensor direction at the last sampling instant so as to avoid a large or sharp change in the sensor direction (and thus the sensor rotation).

In various embodiments, the sensing direction control input is determined based on an optimization of the sensor direction variable with respect to the leader tracking factor function, the area exploration factor function, the dynamic obstacle tracking factor function and the large sensor rotation avoidance factor function.

In various embodiments, the above-mentioned determining (at 114) the navigation control input for controlling a movement of the mobile platform comprises: determining a closest obstacle distance between the follower ground robot and a closest scene portion thereto based on the scene point set; determining an obstacle safety level of the follower ground robot based on the closest obstacle distance; and determining the navigation control input based on the obstacle safety level of the follower ground robot.

In various embodiments, the obstacle safety level comprises a danger level determined based on the closest obstacle distance with respect to a danger level threshold, a safe level determined based on the closest obstacle distance with respect to a safe level threshold and a transition level determined based on the danger level threshold and the safe level threshold (e.g., between the danger level threshold and the safe level threshold).

In various embodiments, the method 100 further comprises determining an available navigation direction set for obstacle avoidance based on the scene point set. In various embodiments, based on determining that the obstacle safety level of the follower ground robot is at the transition level, the navigation control input is determined based on a desired obstacle avoidance direction and a desired navigation direction. In this regard, the desired obstacle avoidance direction is determined based on the available navigation direction set (e.g., a desired direction determined for obstacle avoidance under an obstacle environment) and the desired navigation direction is determined based on desired pixel coordinates of the leader ground robot for maintaining the leader ground robot within the field of view of the depth sensor (e.g., a desired direction determined for tracking the leader ground robot under an obstacle-free environment).

In various embodiments, the desired obstacle avoidance direction is determined based on an available navigation direction in the available navigation direction set that is the same as or closest to the desired navigation direction.

In various embodiments, the available navigation direction set comprises available navigation directions determined based on scene points in the scene point set which have associated therewith the relative distance between the follower ground robot and the scene portion satisfying a predetermined distance threshold condition. Accordingly, in various embodiments, the relative angle associated with each scene point in the scene point set having associated therewith a relative distance between the follower ground robot and the scene portion satisfying the predetermined distance threshold condition is, or corresponds to, an available navigation direction.

In various embodiments, the above-mentioned determining (at 114) the navigation control input comprises: determining new desired pixel coordinates for tracking the leader ground robot based on the desired obstacle avoidance direction, the desired navigation direction and a weighting function configured to output a weight value dependent on the closest obstacle distance for weighting the desired obstacle avoidance direction and the desired navigation direction depending on the closest obstacle distance; and determining the navigation control input based on the pixel coordinates of the leader ground robot and the new desired pixel coordinates for leader ground robot.

In various embodiments, the above-mentioned determining (at 112) the sensing direction control input for controlling the sensing direction of the depth sensor and the above-mentioned determining (at 114) the navigation control input for controlling the movement of the mobile platform are based only on the depth sensor for feedback of a surrounding environment (e.g., no additional sensor and no inter-robot communication). In various embodiments, the depth sensor is a RGB-D (Red Green Blue-Depth) camera.

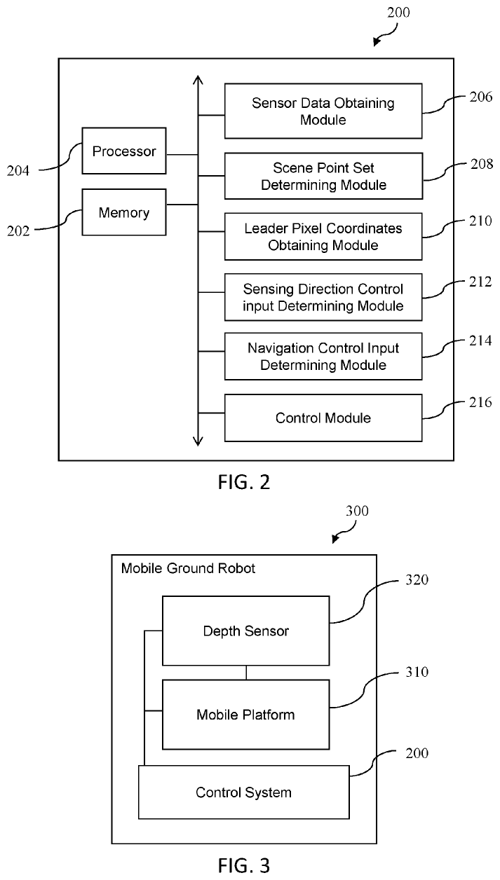

FIG. 2 depicts a schematic block diagram of a control system 200 for controlling a follower ground robot for tracking a leader ground robot as a leader-follower pair, according to various embodiments of the present invention, corresponding to the above-mentioned method 100 of controlling a follower ground robot for tracking a leader ground robot as described hereinbefore according with reference to FIG. 1 according to various embodiments of the present invention. The control system 200 comprises: at least one memory 202; and at least one processor 204 communicatively coupled to the at least one memory 202 and configured to perform the method 100 of controlling a follower ground robot for tracking a leader ground robot as described hereinbefore according to various embodiments of the present invention. Accordingly, the at least one processor 204 is configured to: obtain a current color image and associated depth information of a scene captured by the depth sensor; determine a scene point set based on the current color image and the associated depth information, the scene point set comprising a plurality of scene points, each scene point corresponding to a pixel point of the current color image and has associated therewith a relative distance and a relative angle between the follower ground robot and a scene portion at the pixel point of the current color image; obtain pixel coordinates of the leader ground robot in the current color image; determine a sensing direction control input for controlling, by rotating the depth sensor, a sensing direction of the depth sensor based on the scene point set; determine a navigation control input for controlling a movement of the mobile platform based on the pixel coordinates of the leader ground robot and the scene point set; and control the sensing direction of the depth sensor and the movement of the mobile platform based on the sensing direction control input and the navigation control input, respectively, for tracking the leader ground robot and maintaining the leader ground robot within a field of view of the depth sensor.

It will be appreciated by a person skilled in the art that the at least one processor 204 may be configured to perform various functions or operations through set(s) of instructions (e.g., software modules) executable by the at least one processor 204 to perform various functions or operations. Accordingly, as shown in FIG. 2, the system 200 may comprise: a sensor data obtaining module (or a sensor data obtaining circuit) 206 configured to obtain a current color image and associated depth information of a scene captured by the depth sensor; a scene point set determining module (or a scene point set determining circuit) 208 configured to determine a scene point set based on the current color image and the associated depth information, the scene point set comprising a plurality of scene points, each scene point corresponding to a pixel point of the current color image and has associated therewith a relative distance and a relative angle between the follower ground robot and a scene portion at the pixel point of the current color image; a leader pixel coordinates obtaining module (or a leader pixel coordinates obtaining circuit) 210 configured to obtain pixel coordinates of the leader ground robot in the current color image; a sensing direction control input determining module (or a sensing direction control input determining circuit) 212 configured to determine a sensing direction control input for controlling, by rotating the depth sensor, a sensing direction of the depth sensor based on the scene point set; a navigation control input determining module (or a navigation control input determining circuit) 214 configured to determine a navigation control input for controlling a movement of the mobile platform based on the pixel coordinates of the leader ground robot and the scene point set; and a control module (or a control circuit) 216 configured to control the sensing direction of the depth sensor and the movement of the mobile platform based on the sensing direction control input and the navigation control input, respectively, for tracking the leader ground robot and maintaining the leader ground robot within a field of view of the depth sensor.

It will be appreciated by a person skilled in the art that the above-mentioned modules are not necessarily separate modules, and two or more modules may be realized by or implemented as one functional module (e.g., a circuit or a software program) as desired or as appropriate without deviating from the scope of the present invention. For example, two or more of the sensor data obtaining module 206, the scene point set determining module 208, a leader pixel coordinates obtaining module 210, a sensing direction control input determining module 212, a navigation control input determining module 214 and the control module 216 may be realized (e.g., compiled together) as one executable software program (e.g., software application or simply referred to as an “app”), which for example may be stored in the at least one memory 202 and executable by the at least one processor 204 to perform the corresponding functions or operations as described herein according to various embodiments of the present invention.

In various embodiments, the control system 200 for controlling a follower ground robot for tracking a leader ground robot corresponds to the method 100 of controlling a follower ground robot for tracking a leader ground robot as described hereinbefore with reference to FIG. 1, therefore, various operations, functions or steps configured to be performed by the least one processor 204 may correspond to various operations, functions or steps of the method 100 described hereinbefore according to various embodiments, and thus need not be repeated with respect to the control system 200 for clarity and conciseness. In other words, various embodiments described herein in context of methods (e.g., the method 100 of controlling a follower ground robot for tracking a leader ground robot) are analogously valid for the corresponding systems or devices (e.g., the control system 200 for controlling a follower ground robot for tracking a leader ground robot), and vice versa. For example, in various embodiments, the at least one memory 202 may have stored therein the sensor data obtaining module 206, the scene point set determining module 208, a leader pixel coordinates obtaining module 210, a sensing direction control input determining module 212, a navigation control input determining module 214 and/or the control module 216, which respectively correspond to various operations, functions or steps of the method 100 of controlling a follower ground robot for tracking a leader ground robot as described hereinbefore according to various embodiments, which are executable by the at least one processor 204 to perform the corresponding operations, functions or steps as described herein.

A computing system, a controller, a microcontroller or any other system providing a processing capability may be provided according to various embodiments in the present invention. Such a system may be taken to include one or more processors and one or more computer-readable storage mediums. For example, the control system 200 described hereinbefore may include at least one processor (or controller) 204 and at least one computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of various functions or operations may also be understood as a “circuit” in accordance with various other embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

The present specification also discloses a system (e.g., which may also be embodied as one or more devices or apparatuses), such as the control system 200, for performing various operations, functions or steps of various methods described herein. Such a system may be specially constructed for the required purposes or may comprise a general purpose computer system selectively activated or reconfigured by a computer program stored in the computer system. In general, various algorithms that may be presented herein are not limited to being implemented or executed by any particular computer system. Alternatively, the construction of more specialized computer system to perform various operations, functions or steps of various methods described herein may be provided as desired or as appropriate without going beyond the scope of the present invention.

In addition, the present specification also at least implicitly discloses computer program(s) or software/functional module(s), in that it would be apparent to a person skilled in the art that various operations, functions or steps of various methods described herein may be put into effect by computer code. The computer program(s) is not intended to be limited to any particular programming language and implementation thereof, and it will be appreciated by a person skilled in the art that a variety of programming languages and coding thereof may be used to implement the computer program(s). Moreover, the computer program(s) is not intended to be limited to any particular control flow as there are a variety of programming languages which can use different control flows. It will be appreciated by a person skilled in the art that a computer program may be stored on any computer-readable storage medium (non-transitory computer-readable storage medium), such as but not limited to, a magnetic disk, an optical disk or a memory chip. For example, a computer program stored on a computer-readable storage medium may be loaded and executed on a computer system to implement various operations, functions or steps of various methods described herein according to various embodiments of the present invention.

Accordingly, in various embodiments, there is provided a computer program product, embodied in one or more computer-readable storage mediums (non-transitory computer-readable storage medium), comprising instructions (e.g., the sensor data obtaining module 206, the scene point set determining module 208, a leader pixel coordinates obtaining module 210, a sensing direction control input determining module 212, a navigation control input determining module 214 and/or the control module 216) executable by one or more computer processors to perform a method 100 of controlling a follower ground robot for tracking a leader ground robot as described hereinbefore with reference to FIG. 1 according to various embodiments of the present invention. Accordingly, various computer programs or software modules described herein may be stored in a computer program product receivable by a system therein, such as the control system 200 as shown in FIG. 2, for execution by at least one processor 204 of the control system 200 to perform various operations, functions or steps of various methods described herein according to various embodiments of the present invention.

It will be appreciated by a person skilled in the art that various modules described herein (e.g., the sensor data obtaining module 206, the scene point set determining module 208, a leader pixel coordinates obtaining module 210, a sensing direction control input determining module 212, a navigation control input determining module 214 and/or the control module 216) may be software module(s) realized by computer program(s) or set(s) of instructions executable by a computer processor to perform various functions or operations. Various modules described herein (e.g., the sensor data obtaining module 206, the scene point set determining module 208, a leader pixel coordinates obtaining module 210, a sensing direction control input determining module 212, a navigation control input determining module 214 and/or the control module 216) may also be implemented as hardware module(s) being functional hardware unit(s) designed to perform various functions or operations. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. It will also be appreciated by a person skilled in the art that a combination of hardware and software modules may be implemented. Furthermore, various operations, functions or steps of various methods described herein may be performed in parallel rather than sequentially as desired or as appropriate (e.g., as long as it does not render the method(s) inoperable or unsatisfactory for its intended purpose).

FIG. 3 depicts a schematic drawing of a mobile ground robot 300 according to various embodiments of the present invention. The mobile ground robot 300 comprises: a mobile platform 310 configured to travel on a ground; and a depth sensor 320 configured to be rotatable with respect to the mobile platform 310 for rotating a sensing direction; and the control system 200 as described herein according to various embodiments communicatively coupled to the mobile platform 310 and the depth sensor 320 for controlling the mobile ground robot as a follower ground robot for tracking a leader ground robot as a leader-follower pair.

It will be appreciated by a person skilled in the art that the depth sensor 320 is not limited to any particular or specific arrangement in the mobile ground robot 300, and may be arranged as desired or as appropriate as long as the depth sensor 320 is rotatable with respect to the mobile platform 310 for changing/adjusting the field of view of the depth sensor 320 (e.g., rotatable about an axis at least substantially perpendicular to the ground).

It will be understood by a person skilled in the art that the present invention is not limited to any particular type or configuration of mobile ground robot, as well as any particular type or configuration of mobile platform, as long as the method 100 or the control system 200 for controlling the mobile ground robot (as a follower ground robot) for tracking a leader ground robot as described herein according to various embodiments can be implemented in the mobile ground robot to provide the mobile ground robot with vision-based leader-follower formation tracking control capability or functionality. Various configurations and operating mechanisms or principles of ground mobile robots (e.g., robot operating system (ROS)), as well as ground mobile platforms, are known in the art and thus need not be described herein for clarity and conciseness.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element, unless stated or the context requires otherwise. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

Various example embodiments relate to vision-based leader-follower formation tracking control of mobile ground robots in the obstacle environment without requiring prior map and data communication devices, using only an onboard depth sensor (or more specifically, a RGB-D camera) configured to produce a color image and associated depth information (e.g., a depth image) for feedback (or sensor feedback) of the surrounding environment or area. In particular, various example embodiments seek to solve the formation control problem for multiple mobile robots in the leader-follower configuration using only a RGB-D camera for feedback of the surrounding environment. Conventionally, mobile robot formation control relies on various systems/devices such as global localization systems, communication devices and onboard LiDAR sensors/cameras to detect neighbouring mobile robots and obstacles, and to measure the relative positions between mobile robots. For example, existing research typically employs at least two sensors, including a camera and a LiDAR. However, the reliance on multiple devices/systems for formation control of mobile robots can significantly increase the cost of implementing formation algorithms and limit their practical application. For example, global localization systems such those provided by Vicon and Optitrack are very expensive (e.g., typically over SGD 10,000) but they can only cover a quite small area (e.g., not more than 100 square meters). Besides, LiDAR sensors typically cost thousands to tens of thousands of dollars (SGD). In contrast, various example embodiments note that a RGB-D camera is significantly more cost effective (e.g., typically only a few hundred dollars (SGD)), thereby various example embodiments seek to avoid expensive global positioning systems with limited working range and expensive LIDAR sensors. Accordingly, various example embodiments seek to develop mobile robot formation tracking control methods or algorithms that rely only on a single onboard RGB-D camera on the follower ground robot for feedback of the surrounding environment (i.e., without requiring prior map and data communication devices and without requiring multiple sensors (including without requiring a LiDAR sensor)) so as to significantly reduce the cost and improve practicality. However, various example embodiments note that due to the limited field of view (FOV) of the RGB-D camera, the detection of neighbouring mobile robots and nearby obstacles may be incomplete or insufficient, resulting in the leader-follower formation failure and/or collisions with obstacles. For example and without limitation, the Intel Realsense D435 camera has a FOV of only about 69 degrees horizontally and 42 degrees vertically, while the FOV of Kinect V1 is only about 57 degrees horizontally and 43 degrees vertically. Conventionally, mobile robots equipped with a limited FOV camera can only observe part of surrounding obstacles and obtain discontinuous visual feedback from neighbouring robots. The incomplete obstacle measurements can lead to collisions between robots and unobserved obstacles, while intermittent observation of neighbouring robots can lead to the failure of formation tracking. In particular, various example embodiments found that the limited FOV of the RGB-D camera introduces three significant challenges: 1) intermittent observation of the leader, 2) partial detection of obstacles, and 3) conflicting observations of the leader and obstacles.

To address these technical problems due to the camera limited FOV in the leader-follower formation tracking control, various example embodiments provide a vision-based leader-follower formation tracking control method based on a rotatable RGB-D camera (having limited FOV). In various example embodiments, the leader-follower formation tracking control of mobile robots may be divided into several leader-follower pairs, where each leader-follower pair include a leader robot and a follower robot following the leader robot. Each follower robot is equipped with a single RGB-D camera for sensing the surrounding environment, for example, driven by (rotatable by) a servo motor under it for changing a sensing direction thereof. In various example embodiments, the leader-follower formation control may involve two aspects. Firstly, the leader-follower formation control is developed for an environment without obstacles (i.e., an obstacle-free environment). In this regard, a controller is designed for the follower robot to track to leader robot such that the leader robot is always maintained in the limited FOV of the RGB-D camera onboard the follower robot without inter-robot communication devices and camera rotation. In other words, a controller is first developed that enables the follower to achieve continuous observation and formation tracking of the leader without obstacles and depth information (e.g., depth image). Secondly, the leader-follower formation control for an obstacle environment is developed. In this regard, the follower camera is configured to accomplish the detection of the leader robot and obstacles simultaneously with only a limited FOV. To enlarge the limited FOV of the camera, in various example embodiments, the camera is rotated and the rotation angle (or sensing direction) may be determined by considering the detection of the leader and static obstacles (corresponding to a leader tracking factor and an area exploration factor), the avoidance of large (or sharp) camera rotation (corresponding to a large sensor rotation avoidance factor) and the tracking of the dynamic obstacles (corresponding to a dynamic obstacle tracking factor). Based on the visual feedback from the rotatable camera, in various example embodiments, a multi-objective controller is designed for the follower robot to achieve formation tracking and collision avoidance with both static and dynamic obstacles at the same time. Accordingly, to address the partial detection of obstacles, various example embodiments configure a rotating device that allows the RGB-D camera to actively extend its observation range and resolve conflicts (e.g., conflicting objectives) between obstacle and leader detections. Based on the camera feedback from the RGB-D camera and the above-mentioned controller for an obstacle-free environment, a multi-objective controller is provided that enables the follower to achieve formation tracking and obstacle avoidance simultaneously, without requiring data communication (e.g., inter-robot communication such as leader velocity) or prior maps as well as without requiring a LiDAR sensor, thus improving cost effectiveness and practicality, especially in an environment or area with obstacles. Therefore, various example embodiments advantageously achieve leader-follower formation tracking control under an environment with obstacles relying only on a single onboard depth sensor (more specifically, a RGB-D camera) on the follower ground robot for feedback of the surrounding environment.

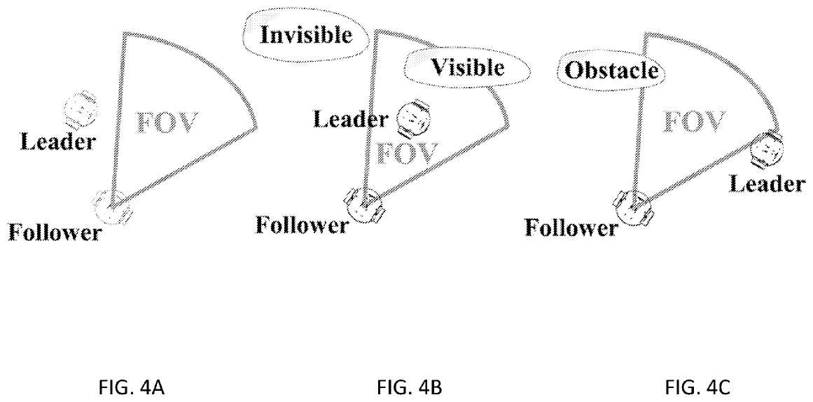

The emergence of RGB-D cameras presents a new opportunity to address the challenges of formation tracking with a single sensor, as the camera's color and depth images can replace the roles of a traditional camera and LiDAR, respectively. However, as explained above, various example embodiments note that commercial RGB-D cameras typically have a limited FOV due to cost and calibration considerations. This limitation creates three significant technical problems for leader-follower formation tracking control of mobile robots. First, the follower cannot ensure that the leader is always in its FOV, such as illustrated in FIG. 4A. In this case, the follower may be unable to find the leader, resulting in the failure of the formation tracking. Second, the follower's ability to detect obstacles is restricted, such as illustrated in FIG. 4B. The follower can only see obstacles in its FOV. Therefore, conventionally, collisions with those invisible/undetected static and dynamic obstacles are almost inevitable. Third, the followers' observations of the leader and obstacles interfere with each other, such as illustrated in FIG. 4C. For example, when an obstacle and the leader are located in opposite directions, observing one may lead to losing sight of the other. Therefore, achieving both formation tracking and obstacle avoidance with a single limited FOV camera is a challenging problem for mobile robots.

To address the above-mentioned technical problems arising from a limited FOV, various example embodiments seek to provide a vision-based leader-follower formation tracking control method which fulfills a number of objectives/tasks while achieving formation tracking, including 1) maintaining the visibility of the leader, 2) expanding the range of obstacle detection, and 3) coordinating (or balancing) the observations of the leader and obstacles. In this regard, various example embodiments found that various conventional algorithms that employ limited FOV cameras disregard visibility maintenance of the leader and obstacle avoidance. Consequently, they are unable to avoid tracking failures due to the leader leaving the FOV of the camera and collisions with obstacles. There may be certain previous works that achieve visibility maintenance of the leader using limited FOV cameras. For example, a previous work provide theoretical analysis of the formation problem for mobile robots with sector sensing areas. As further examples, in certain previous works, formation tracking is accomplished using limited FOV RGB-D cameras Kinect V1 and RealSense D435i, while other previous works consider the scenario where the feature depth is unavailable in addition to FOV constraints. Nevertheless, these previous works neglect obstacle detection and avoidance, seriously hindering their practical applications in obstacle environments.

A number of previous techniques have addressed the issue of obstacle avoidance in mobile robot formation with limited FOV cameras. However, each of these techniques has its limitations. For instance, a number of previous techniques require additional expensive panoramic LiDAR sensors to provide obstacle detection for the follower, whereby the associated disadvantages have been explained hereinbefore. While a number of other previous techniques rely on global maps or global localization systems, which are expensive, require communication devices, and have a limited workspace, making them unsuitable or undesirable for practical use. As described above according to various example embodiments, to address the above-mentioned three challenging technical problems, a leader-follower formation tracking control method is provided involving an active rotation device for the follower camera for actively rotating it. This advantageously enables the follower robot to enlarge its observation range, record/detect more existing/surrounding obstacles and balance the detection of the leader robot and undetected obstacles. In various example embodiments, the follower robot may then determine a navigation direction based on a balance between a direction determined for obstacle avoidance (corresponding to a desired obstacle avoidance direction) and a direction determined for tracking the leader robot in an environment without obstacles, and then moves along the navigation direction determined to achieve both formation tracking (or leader tracking) and obstacle avoidance simultaneously.

Accordingly, the leader-follower formation tracking control method, or more particularly, the method of controlling a follower ground robot for tracking a leader ground robot as a leader-follower pair, according to various example embodiments of the present invention (which may herein be referred to as the present control method) possesses a number of advantages/contributions as follows:
compared to various existing techniques, the present control method uses a minimum number of sensors to achieve formation tracking under unknown obstacles, and more specifically, only one RGB-D camera, thereby saving cost, space, and calibration time.
the problems of discontinuous leader observation, incomplete obstacle observation and mutual interference between leader and obstacle observations due to the limited FOV are addressed or substantially mitigated. In the absence of obstacles, a controller is designed for the follower to achieve continuous observation and formation tracking of the leader without depth images. For obstacle environments, a camera rotation technique is provided to actively extend the incomplete obstacle observation and resolve its conflicts with the leader observation.
a multi-objective controller is provided based on the above-mentioned controller configured for an obstacle-free environment, which can achieve formation tracking and obstacle avoidance (e.g., static and cooperative dynamic obstacles) concurrently without the need for inter-robot communication and leader velocity.

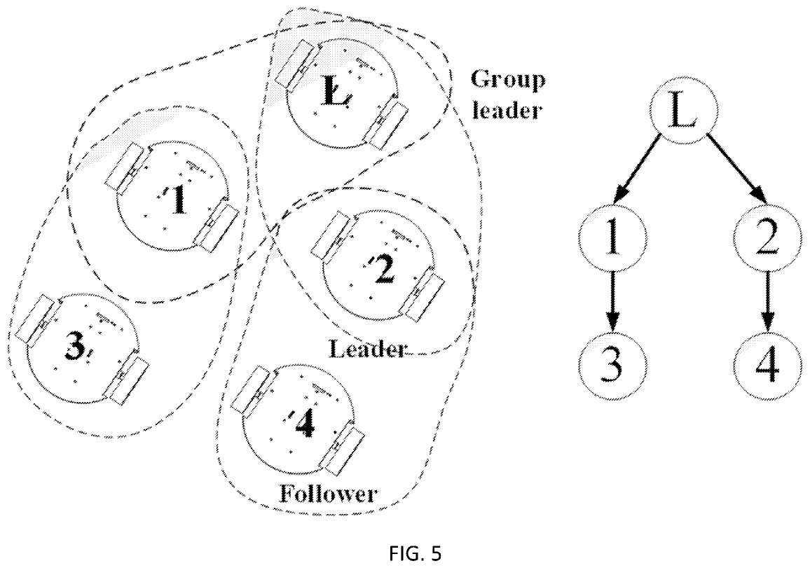

In various example embodiments, as illustrated in FIG. 5, the mobile robot formation can be divided into a number of leader-follower robot pairs. For example, the mobile robot formation shown in FIG. 5 has five robots. There may be an overall group leader robot L in the front and four follower robots behind. In order for all follower robots to keep track of the group leader robot L, the leader-follower structure is also used between the followers. For example, as illustrated in FIG. 5, the follower robots 1 and 2 serve as the followers of the group leader robot L, while the follower robots 3 and 4 follow the robots 1 and 2 (as leader robots to follower robots 3 and 4), respectively. With this mobile robot formation structure, the mobile robot formation can be employed to achieve various formation tracking tasks and is scalable (e.g., can be expanded to a larger scale as desired or as appropriate). Accordingly, when every pair of leader-follower robots in the mobile robot group reaches a desired relative position between the leader and follower robots, the whole mobile robot group accomplishes the formation control mission. Accordingly, in various example embodiments, the overall robot formation control problem for a mobile robot group is reduced to the formation tracking problem for a pair of leader-follower robots, that is, leader-follower formation tracking control.

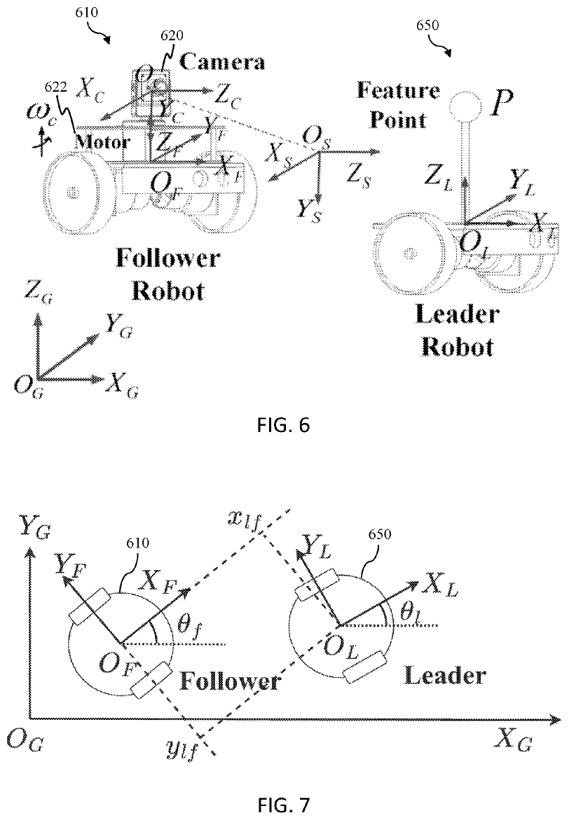

FIG. 6 depicts a schematic drawing illustrating a relationship between a pair of leader-follower robots according to various example embodiments of the present invention. As shown, the follower robot 610 is equipped with an RGB-D camera 620 to observe or capture surrounding obstacles and to track the leader robot 650, such as based on a selected feature point P that is tracked and identified by the follower robot 610. However, in practice and as explained above, there are a number of problems associated with conventional robot formation control. Firstly, due to the limited camera FOV, conventionally, the follower robot can only observe certain obstacles in the specific angle range. Therefore, collisions between the follower robot and unobserved/undetected obstacles are nearly unavoidable. Secondly, the leader robot can easily go out of the limited FOV of the follower camera during the formation control, resulting in failure of the formation tracking. To address these problems, in various example embodiments, a camera rotator 622 is provided (e.g., a servo motor mounted under the follower camera 620) and configured to rotate the follower camera 620 (e.g., about an axis at least substantively perpendicular to the ground) to explore more nearby obstacles and track the moving leader 650.

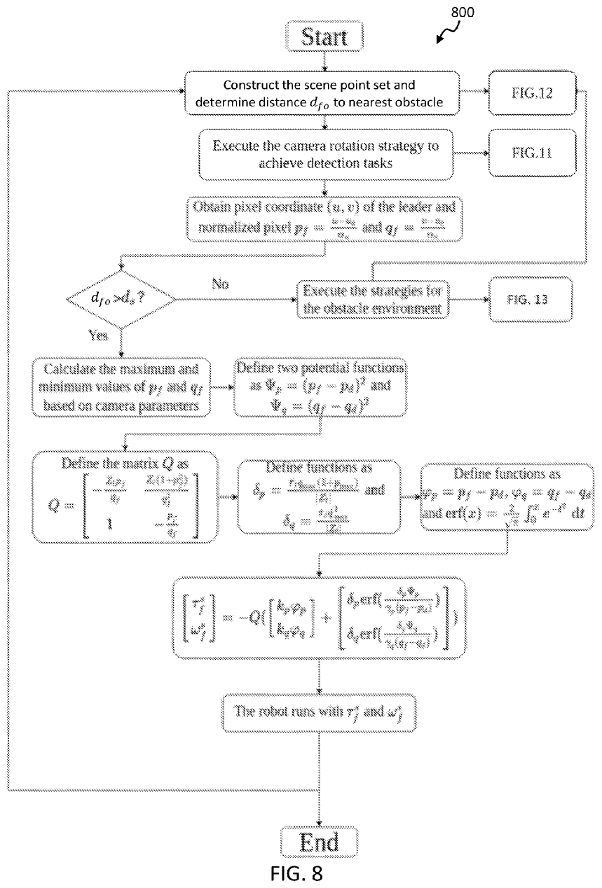

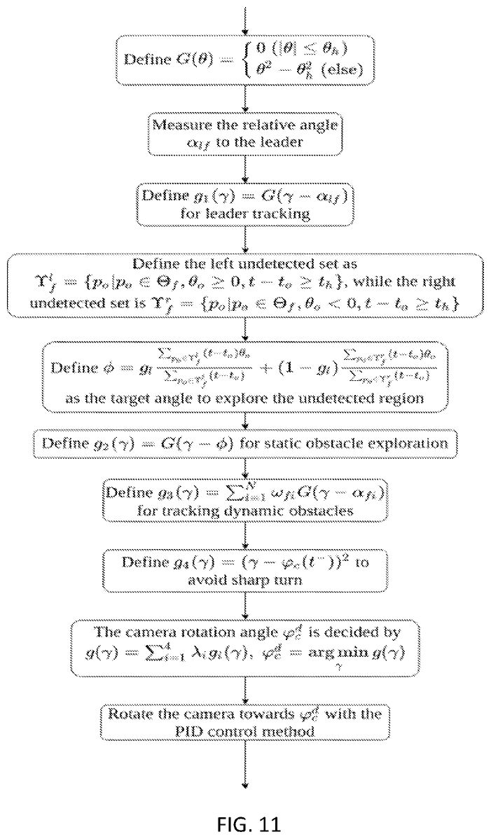

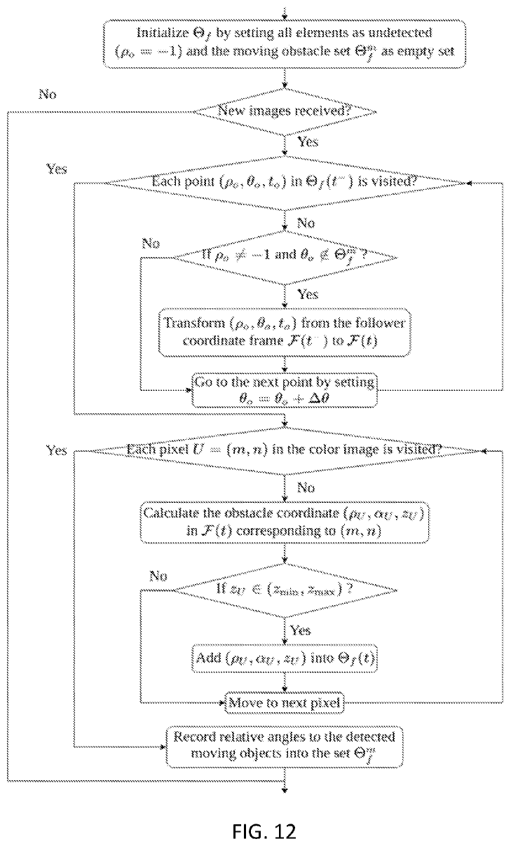

With the visual feedback from the rotatable camera 620, the follower robot 610 is configured to execute a control algorithm according to various example embodiments of the present invention to achieve the formation control with the corresponding leader 650 in an obstacle environment. FIG. 8 depicts a schematic flow diagram of an example leader-follower formation tracking control method 800 according to various example embodiments of the present invention. As shown, based on the color image and associated depth information (e.g., an associated depth image) of a scene produced by the camera 620, the follower robot 610 may build a scene point set Θ_{f} (e.g., a number of scene points in the scene point set may correspond to obstacle points, each obstacle point corresponding to a pixel point capturing an obstacle portion of an obstacle thereat, therefore, the scene point set may also be referred to as an obstacle set) and calculate the distance d_{fo} from the nearest obstacle (or obstacle portion thereof) to the follower robot 610 (which may be referred to as the closest obstacle distance). Each scene point pₒ in the scene point set Θ_{f} may be represented by a vector (ρₒ, θₒ, tₒ), where ρₒ denotes the relative distance to the scene portion (e.g., the scene portion may be an obstacle portion of an obstacle), θₒ denotes the relative angle to the scene portion and tₒ denotes the time when the scene portion was captured (e.g., when the obstacle portion was detected if the scene portion is an obstacle portion). An example method for determining or constructing the scene point set Θ_{f} will be described later below with reference to FIG. 12 according to various example embodiments of the present invention. Subsequently, the follower robot 610 may perform a camera rotation method based on the scene point set Θ_{f} according to various example embodiments for detecting obstacles. An example camera rotation method will be described later below with reference to FIG. 11 according to various example embodiments of the present invention. By performing the camera rotation method, the robot camera 620 is able to rotate to a suitable angle (sensing direction) to balance the tasks of exploring obstacles and tracking the leader given its limited FOV. As shown in FIG. 8, in addition, the leader robot 650 can be detected and measured by the follower robot 610 based on the feature point P of the leader robot 650. The pixel coordinates of P on the image plane of the follower robot 610 may be obtained as (u, v) and the normalized pixels may thus be attained as

$${p}_{f} = \frac{u - {u}_{0}}{{α}_{u}} and {q}_{f} = \frac{v - {v}_{0}}{{α}_{v}} ,$$

where camera parameters αᵤ, αᵥ are focal lengths in terms of pixels and (u₀, v₀) represents the principal point.

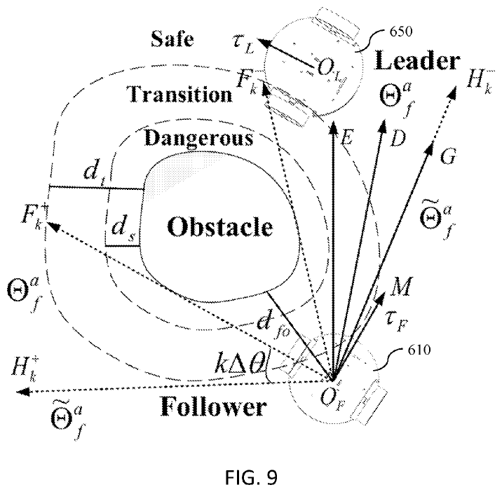

FIG. 9 depicts a schematic drawing illustrating a workspace associated with the follower robot 610 according to various example embodiments of the present invention. As shown in FIG. 9, the workspace of the follower robot 610 may be divided into a number of regions (e.g., three regions) including a safe region, a transition region and a danger region, based on the distance d_{fo} of the nearest obstacle to the follower robot 610. For example, when d_{fo} is larger than a predefined safe distance threshold dₜ, the follower robot 610 is in a safe region, while it is in a danger region if d_{fo}≤dₛ. Furthermore, the follower robot 610 is in a transition region when it is located between the safe region and the danger region (i.e., dₜ>d_{fo}>dₛ).

In various example embodiments, in the safe region, the follower robot 610 generally does not need to consider obstacle avoidance and may only perform the leader tracking task for an obstacle-free environment. In this regard, the controller for controlling the movement of the follower robot 610 may be configured to generate navigation instructions

$$( {τ}_{f}^{s} , {ω}_{f}^{s} )$$

for controlling the follower robot 610 for tracking the leader robot 650 based on the normalized pixel coordinates (p_{f} and q_{f}) of the feature point P on the image plane of the follower robot 610. An example method of generating the navigation instructions (navigation control inputs) for controlling the follower robot 610 is shown in FIG. 8, where the desired values of p_{f} and q_{f} for tracking the leader robot 650 are denoted as p_{d} and q_{d}, respectively, and may be determined based on the desired relative position between the leader and follower robots. As shown in FIG. 8, in the example control law in the safe region, the maximum and minimum values of p_{f} as pₘₐₓ and pₘᵢₙ may be determined based on the camera parameters. For the pixel q_{f}, the maximum and minimum values may be denoted by qₘₐₓ and qₘᵢₙ. Then, two potential functions may be defined for p_{f} and q_{f}, respectively, whose minimum values are 0 and obtained at the desired values p_{d} and q_{d}. Next, a matrix Q is designed to transform the pixel coordinates into Cartesian coordinates, while the parameters δₚ, δ_{q} and the function erf(x) may be applied to estimate the unknown leader velocity. The functions φₚ and φ_{q} may be obtained based on the feedback control laws, which are combined with the velocity estimation items generated by δₚ, δ_{q} and erf(x). By pre-multiplying the matrix Q, the combined control laws above are transformed from the Cartesian coordinate system into the pixel coordinate system. In this manner, the control laws (navigation control input)

$${τ}_{f}^{s} and {ω}_{f}^{s}$$

for the follower robot 610 in the safe region are determined. For example, compared to various existing methods, the above-described control method according to various example embodiments has several benefits. Firstly, the follower robot 610 is able to complete formation tracking of the leader 650 and drive the detected pixel coordinates p_{f} and q_{f} to the (or neighbourhood of) the desired pixel coordinates p_{d} and q_{d} without inter-robot communication. Secondly, with the above-described control method for an obstacle-free environment, the leader robot 650 will always be located within the image plane of the follower camera 620, without the need for camera rotation. Furthermore, the convergence rate of the detected pixel coordinates p_{f} and q_{f} to the desired pixel coordinates p_{d} and q_{d} and the tracking errors can be adjusted by appropriately selecting/setting the parameters kₚ, k_{q}, γₚ and γ_{q}.

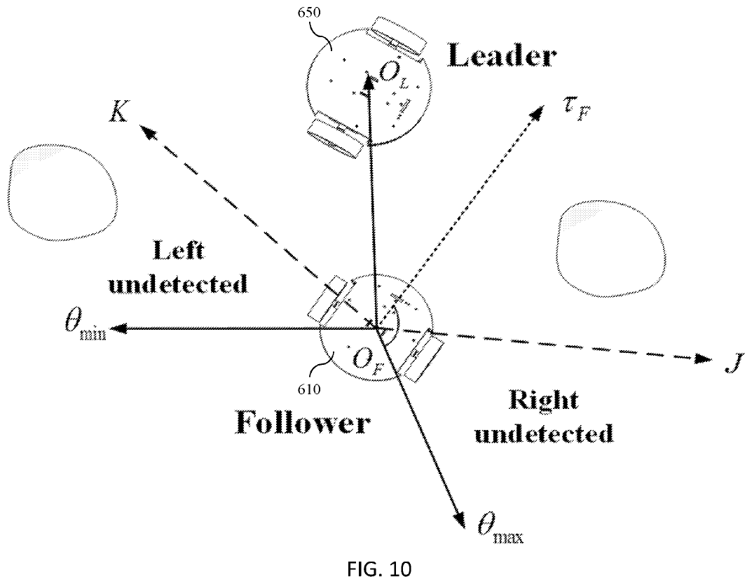

FIG. 10 depict a schematic drawing illustrating a number of example factors considered by the follower robot 610 when performing the camera rotation method according to various example embodiments of the present invention. As shown, based on the example factors, the camera rotation method seeks to rotate the follower camera 620 in the direction of the leader robot 650 to obtain continuous visual feedback of the leader robot 650, so that the leader robot 650 can be detected and the pixel coordinates of the feature P on the leader robot 650 can be obtained. Furthermore, the camera rotation method seeks to control the follower camera 620 to explore as many nearby obstacles as possible. In various example embodiments, the obstacle detection workspace may be divided into left and right regions of the follower robot 610 centered on the follower robot's forward direction (τ_{F}). In this regard, the camera rotation method may be configured to turn the follower camera 620 to the left when the left unexplored area is larger (compared to the right unexplored area) and to the right when the right unexplored area is larger (compared to the left unexplored area). Since the follower robot 610 usually moves forward when performing the tracking task, it may thus be not necessary for the follower robot 610 to observe for obstacles behind. Thus, a maximum θₘₐₓ and a minimum value θₘᵢₙ may be set for the obstacle observation range, instead of the entire circumference about the follower robot 610.

FIG. 11 depicts a schematic flow diagram of an example camera rotation method according to various example embodiments of the present invention (e.g., corresponding to determining (at 112) a sensing direction control input for controlling, by rotating the depth sensor, a sensing direction of the depth sensor based on the scene point set as described hereinbefore according to various embodiments of the present invention). In the example camera rotation method, four potential functions may be defined for four factors being considered in the example camera rotation method, including a leader tracking factor, an area/environment exploration (for obstacles) factor, a dynamic obstacle tracking factor and a large (or sharp) camera rotation avoidance factor. In FIG. 11, the example function g₁ is defined based on the leader tracking factor for tracking the leader robot 650. For example, the example function g₁ may be configured to have a minimum value of 0 when the follower camera 620 is directly facing the leader robot 650. The example function g₂ is defined based on the area/environment exploration factor and may be configured to control the follower camera 620 to explore the nearby static obstacles in a manner which rotates the follower camera 620 to a sensing direction associated with more unexplored regions or obstacles. For example, with reference to FIG. 10, two scene point subsets

$${Υ}_{f}^{l} and {Υ}_{f}^{γ}$$

may be provided to represent the left and right undetected areas, relatively. For example, when a scene point (or an angle (relative direction) associated with a scene point) in the scene point set has not been updated for more than a predefined threshold time period tₕ, it may be set as an undetected scene point (or angle). Based on the two scene point subsets, the example camera rotation method may decide whether to rotate the follower camera 620 towards the left or right area. If the left undetected area is larger, the example function g₂ may be configured to control the follower camera 620 to rotate towards the left and the value of gₗ is set to 1. Otherwise, the example function g₂ may be configured to control the follower camera 620 to turn to the right side and gₗ is set to 0. An example function g₃ is defined based on the dynamic obstacle tracking factor for tracking dynamic obstacles, where ω_{fi} denotes the angular velocity of the i^{th} dynamic obstacle around the follower robot 610 and N denotes the number of dynamic obstacles. An example function g₄ is defined based on the large camera rotation avoidance factor for avoid the large turn of the follower camera 620, where φ_{c}(t⁻) denote the camera angle at last (immediately previous) sampling instant. Based on these four potential functions g₁, g₂, g₃ and g₄, in various example embodiments, the desired or target camera rotation angle

$${φ}_{c}^{d}$$

(i.e., sensing direction) may be determined by calculating or optimizing the angle (e.g., sensor direction variable γ) that makes the sum of the four potential functions as small as possible, that is, optimizing the desired or target camera rotation angle with respect to the four potential functions. The follower camera 620 may then rotate to the desired camera rotation angle determined based on PID (Proportional-integral-derivative controller) control.

FIG. 12 depicts a schematic flow diagram of an example method of constructing a scene point set Θ_{f} according to various example embodiments of the present invention (e.g., corresponding to determining (at 108) a scene point set based on the current color image and the associated depth information as described hereinbefore according to various embodiments of the present invention). At the beginning, the scene point set Θ_{f} may be initialized by setting all scene points as undetected and the moving/dynamic obstacle set

$${Θ}_{f}^{m}$$

as empty set. When a new image is received, the scene points in the scene point set Θ_{f} from the follower coordinate frame at last (immediately previous) time instance may be transformed to the current follower frame. In this way, the previous obstacle observation results can be utilized to increase the number of the detected scene points (e.g., including detected obstacle points). In various example embodiments, only the detected and static obstacle points are transformed to the current follower frame, because the position of dynamic obstacles may change. Then, a newly received image (a current color image and associated depth information of a scene) may be processed and scene points derived from the new image may be added into the scene point set. In various example embodiments, the scene point set may be an angle-indexing set comprising scene points, each scene point may correspond to the position of the scene portion at the pixel point in the current frame of the follower robot 610 and may have associated therewith a relative distance and a relative angle between the follower robot 610 and the scene portion (e.g., an obstacle portion). For example, each scene portion having associated therewith a relative distance less than a predefined obstacle threshold may be considered as an obstacle portion. By way of an example only and without limitation, considering an example scene point set [1.0, 1.0, 2.5, 3.0] with an entire angle range of 360 degrees and a resolution of 90 degrees (hence, the example scene point set is indexed by four possible angles/directions). Therefore, the example scene point set may indicate that a first scene point (or a first obstacle point) having associated therewith a relative distance of 1.0 m and a relative angle of 0 degrees, a second scene point (or a second obstacle point) having associated therewith a relative distance of 1.0 m and a relative angle of 90 degrees, a third scene point (or a third obstacle point) having associated therewith a relative distance of 2.5 m and a relative angle of 180 degrees and a fourth scene point (or a fourth obstacle point) having associated therewith a relative distance of 3.0 m and a relative angle of 270 degrees.

In various example embodiments, for each pixel point of the current colour image, a corresponding position of a scene portion at the pixel point in the current frame of the follower ground robot may be determined (i.e., transforming the position of the scene portion from the image coordinate system to the follower coordinate system). Thereafter, a scene point may be added in the scene point set Θ_{f} corresponding to the position of the scene portion at the pixel point in the current frame of the follower ground, subject to being within the range (zₘᵢₙ, zₘₐₓ) to avoid the interference from the scene points at the ceiling or the floor. In various example embodiments, dynamic obstacles may be added to the moving/dynamic obstacle set

$${Θ}_{f}^{m}$$

(being a subset of scene point set Θ_{f}), whereby all dynamic obstacles are assumed to be identified. In this manner, the scene point set Θ_{f} (including obstacle points) can be constructed according to various example embodiments of the present invention. For example, as the follower camera 620 rotates, the number of detected obstacle points in the scene point set Θ_{f} may increase.

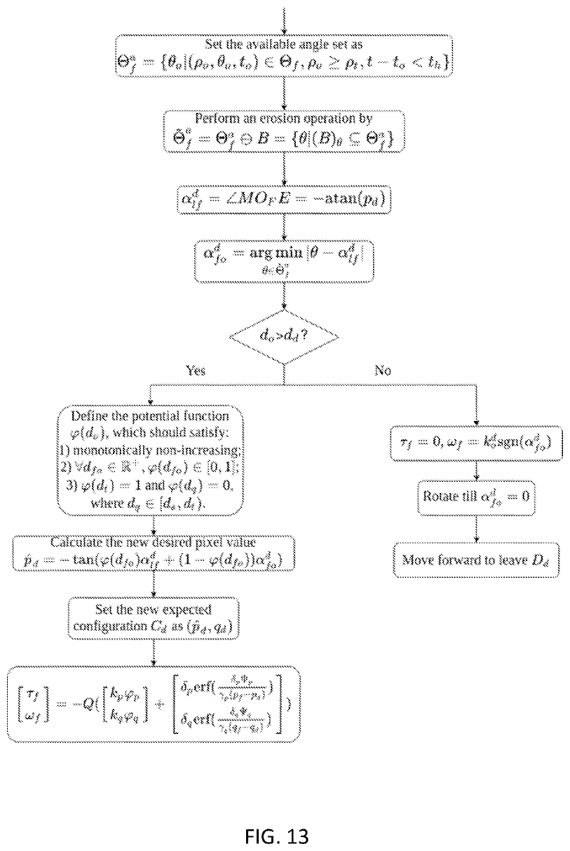

FIG. 13 depicts a schematic flow diagram of an example method of determining the navigation control input (e.g., τ_{f} and ω_{f}) for navigating the follower robot 610 for tracking the leader robot 650 according to various example embodiments of the present invention (e.g., corresponding to the determining (at 114) a navigation control input for controlling a movement of the mobile platform based on the pixel coordinates of the leader ground robot and the scene point set as described hereinbefore according to various embodiments of the present invention). For example, FIG. 13 shows how the follower robot 610 avoids collision with nearby obstacles while maintaining tracking of the leader robot 650 in an obstacle environment. With the constructed scene point set Θ_{f}, the example method builds an available angle (or navigation direction) set

$${Θ}_{f}^{a}$$

comprising free/available angles (or navigation directions) for the follower robot 610 to travel for obstacle avoidance. Then, a set B={iΔθ|i∈Z, |i|≤k} is utilized to perform the erosion operation on the set

$${Θ}_{f}^{a}$$

to obtain

$${\tilde{Θ}}_{f}^{a}$$

by determining

$${\tilde{Θ}}_{f}^{a} = \{ θ \vert {( B )}_{θ} ⊆ {Θ}_{f}^{a} \} ,$$

where (B)_{θ}={b+θ|b∈B} is the erosion operator. Accordingly, the size of k can be adjusted to adjust the size of the set

$${Θ}_{f}^{a} .$$

For example, the larger k is, the smaller the available angle set

$${Θ}_{f}^{a}$$

is, and the more the robot tends to move away from the obstacles. However, when k is too large, the available angle set

$${Θ}_{f}^{a} .$$

may disappear, when will prevent the follower robot 610 from passing through a region available for passing through. Therefore, in various example embodiments, the parameter k is adjusted accordingly. According to the control method in FIG. 8, the desired relative angle

$${α}_{lf}^{d}$$

between the follower robot 610 and the leader robot 650 is −atan(p_{d}). In various example embodiments, the desired obstacle avoidance direction (or angle)

$${α}_{fo}^{d}$$

may be chosen as the direction the same as or closest to the desired navigation direction (or angle)

$${α}_{lf}^{d}$$

within the available angle set

$${\tilde{Θ}}_{f}^{a} .$$

As illustrated in FIG. 9, when the obstacle distance d_{fo} is larger than a distance threshold dₛ (and less than a distance threshold dₜ) in an obstacle area, the follower robot 610 reaches the transition region. In the transition region, a potential function φ(d_{fo}) (e.g., corresponding to a weighting function (or a balancing function)) may be defined for the follower robot 610 to balance the obstacle avoidance task and formation tracking task. As the follower robot 610 approaches closer to a closest obstacle, the value of φ(dₒ) approaches closer to 0 (e.g., φ(dₛ)=0). Otherwise, as the follower robot 610 becomes further to a closest obstacle, the value of φ(dₒ) approaches closer to 1 (e.g., φ(dₜ)=1). The parameter dₛ can be adjusted to improve the efficiency of obstacle avoidance. Furthermore, in various example embodiments, based on φ(d_{fo}), new desired pixel coordinates \hat{p}_{d} may be obtained by mixing the desired relative angle (or desired navigation direction)

$${α}_{lf}^{d}$$

and the desired obstacle avoidance angle

$${α}_{fo}^{d} .$$

Then, the follower robot 610 moves to the new desired pixel coordinates \hat{p}_{d} and rotates away from obstacles. When the follower robot 610 travels into the danger region, in various example embodiments, it first stops to avoid collisions and then rotates to the obstacle avoidance angle

$${α}_{fo}^{d} .$$

When arriving at the obstacle avoidance angle

$${α}_{fo}^{d} ,$$

it moves forward to leave the danger region and move away from obstacles.

For better understanding, the leader-follower formation tracking control method, and more particularly, the method of controlling a follower ground robot (which may herein simply be referred to as the follower) for tracking a leader ground robot (which may herein simply be referred to as the leader) will now be described in further details according to various example embodiments of the present invention.

In leader-following formation tracking control, as described hereinbefore with reference to FIG. 5, a mobile robot group may be regarded as a combination of several leader-follower pairs. Accordingly, without loss of generality, various example embodiments will be described with respect to the formation tracking of a single leader-follower pair, and it will be appreciated by a person skilled in the art that the formation tracking may be applied to each leader-follower pair of the mobile robot group, thus easily extending the formation tracking control to the entire robot formation. As illustrated in FIG. 5, each leader-follower pair includes a leader l and a follower f behind it. For example, the kinematics of the described nonholonomic mobile robot may be expressed as:

$${\dot{x}}_{i} = {τ}_{i} {cosθ}_{i} , \qquad ( Equation 1 )$$

$${\dot{y}}_{i} = {τ}_{i} {sinθ}_{i} ,$$

$${\dot{θ}}_{i} = {ω}_{i}$$

where i∈{l, f}, τᵢ is the linear velocity, ωᵢ is the angular velocity, θᵢ is the heading angle, and pᵢ=[xᵢ, yᵢ]^{T} is the position of robot i in the global frame [symbol] . Since most commercialized mobile robots now provide input interfaces for linear and angular velocities, without loss of generality or limitation, various example embodiments describe the kinematic model (or the robot navigation control model) based on control input τ and ω for simplicity. However, it will be appreciated by a person skilled in the art that the kinematic model may be provided or configured based on other types of control inputs, such as torque and acceleration of the mobile robot.

As shown in FIG. 7, the relative position between the leader 650 and follower 610 is denoted as p_{lf}=[x_{lf}, y_{lf}]^{T}, which may be given by:

$${p}_{if} = R ( {θ}_{f} ) ( {p}_{i} - {p}_{f} ) , \qquad ( Equation 2 )$$

$$R ( {θ}_{f} ) = [ \begin{matrix}{cosθ}_{f} & {sinθ}_{f} \\ - {sinθ}_{f} & {cosθ}_{f}\end{matrix} ]$$

where R(θ) is the rotation matrix. Take the derivative of p_{lf} with respect to time t, there exists:

$$\{ \begin{matrix}{\dot{x}}_{lf} & = {τ}_{l} cos {θ}_{lf} - {τ}_{f} + {y}_{lf} {ω}_{f} \\ {\dot{y}}_{lf} & = {τ}_{l} sin {θ}_{lf} - {x}_{lf} {ω}_{f}\end{matrix} \qquad ( Equation 3 )$$

where θ_{f} denotes the follower heading angle and θ_{lf} denotes the difference between the leader heading angle and the follower heading angle.

The follower 610 is equipped with a rotatable RGB-D camera 620 for changing a sensing direction thereof, driven by a servo motor. The rotation angle (or sensing direction) and angular speed of the motor are denoted by φ_{c} and ω_{c}, respectively. The follower 610 uses the camera 620 to detect the leader 650 and nearby obstacles. In various example embodiments, color images are used to observe the leader 650, depth images are used for obstacle detection, and the camera rotation is for coordinating (or balancing) between obstacle and leader observations and enlarging the environment sensing range.

To detect the leader 650, a feature point P may be fixed at ^{l}P=[0, 0, Zₗ]^{T} in the leader frame [symbol] , where the height Zₗ should satisfy Zₗ≠0 to avoid the singularity. For simplicity, the camera 620 is assumed to be mounted at the origin O_{F} of the follower frame [symbol] , i.e., the origin O_{C} of the camera frame [symbol] coincides with O_{F}. The static frame [symbol] (i.e., when the camera is at the non-rotated state, that is, at φ_{c}=0) is generated by the camera frame [symbol] at φ_{c}=0. Thus, the Cartesian coordinate of P is ^{f}P=[x_{lf}, y_{lf}, Zₗ]^{T} in follower frame [symbol] , ^{s}P=[^{s}X, ^{s}Y, ^{s}Z]^{T}=[−y_{lf},−Zₗ,x_{lf}]^{T} in frame [symbol] and ^{c}P=[^{c}X, ^{c}Y, ^{c}Z]^{T} in camera frame [symbol] , where:

$$\{ \begin{matrix}{}^{c} X & = {x}_{lf} sin {φ}_{c} - {y}_{lf} cos {φ}_{c} \\ {}^{c} Y & = - {Z}_{l} \\ {}^{c} Z & = {x}_{lf} cos {φ}_{c} + {y}_{lf} sin {φ}_{c}\end{matrix} \qquad ( Equation 4 )$$

According to the pinhole camera model, the pixel coordinate I=[u, v]^{T} of P in the image plane satisfies:

$$u = {α}_{u} \frac{{}^{c} X}{{}^{c} Z} + {u}_{0} \qquad ( Equation 5 )$$

$$v = {α}_{v} \frac{{}^{c} Y}{{}^{c} Z} + {v}_{0}$$

where αᵤ>0, αᵥ>0 are the scaling factors of the camera 620 and (u₀, v₀) represents the image center. Due to the limited FOV of the camera, the feature P will be detected by the follower 610 only when it lies within the image plane, written as:

$$u ∈ [ 0 , {u}_{max} ] , v ∈ [ 0 , {v}_{max} ] \qquad ( Equation 6 )$$

where uₘₐₓ and vₘₐₓ denote the maximum values of the pixel coordinates u and v.

To describe the formation tracking of mobile robots, various example embodiments introduce the concept of normalized pixel coordinates C_{f}=(p_{f}, q_{f}) as:

$${q}_{f} = \frac{{}^{s} X}{{}^{s} Z} = - \frac{{y}_{lf}}{{x}_{lf}} \qquad ( Equation 7 )$$

$${q}_{f} = \frac{{}^{s} Y}{{}^{s} Z} = - \frac{{Z}_{l}}{{x}_{lf}}$$

Given the desired relative position

$${p}_{lf}^{d} = {[ {x}_{lf}^{d} , {y}_{lf}^{d} ]}^{T} ,$$

the desired pixel coordinates

$${C}_{f}^{d} = ( {p}_{d} , {q}_{d} )$$

of C_{f} may be uniquely determined according to various example embodiments. Accordingly, the desired pixel coordinates

$${C}_{f}^{d}$$

may be determined based on the desired relative position

$${p}_{lf}^{d}$$

by transforming the desired relative position

$${p}_{lf}^{d}$$

from the Cartesian space to the pixel space.

Due to the limited FOV of the follower camera 620, the follower 610 can only observe obstacles within a specific angle range, which is determined by the range of u and αᵤ, and may be denoted as:

$${α}_{o} ∈ [ {φ}_{c} + atan ( \frac{{u}_{o} - {u}_{max}}{{α}_{u}} ) , {φ}_{c} + atan ( \frac{{u}_{o}}{{α}_{u}} ) ] \qquad ( Equation 8 )$$

where (xₒ, yₒ) is the position of obstacle O of the follower frame [symbol] ,

$${α}_{o} = atan ( \frac{{y}_{o}}{{x}_{o}} )$$

is the relative angle to O, whereby atan denotes the arctangent function. From Equation (8), it can be seen that the obstacle observation range αₒ can be extended by changing the camera rotation angle (or sensing direction) φ_{c}. However, various example embodiments note that changes in φ_{c} also affect u and v, which may break the constraints in Equation (6) and make the leader invisible. To address this technical problem, various example embodiments provide a camera rotation method or strategy configured to balance leader tracking and obstacle detection.

Accordingly, in various example embodiments, a leader-following formation tracking control problem for mobile robots may be proposed as follows. In particular, a leader-following formation tracking problem for mobile robots is proposed for an obstacle environments without access to prior maps and inter-robot communication. The follower robot 610 is only equipped with a limited FOV RGB-D camera 620 for sensing an environment. Given the desired pixel coordinates

$${C}_{f}^{d} = ( {p}_{d} , {q}_{d} )$$

and assume that all obstacles are convex, an objective according to various example embodiments is to design control methods or strategies for the follower 610 to achieve the following:
1) In obstacle-free environments, the leader feature is always visible to the follower 610, as indicated in Equation (6), and the pixel coordinates C_{f} can converge to the desired pixel coordinates

$${C}_{f}^{d}$$

(or a neighbourhood thereof) to realize the formation tracking control, without the need for camera rotation and depth images.
2) In obstacle environments, the follower camera 620 can maintain visibility of leader 650, extend the obstacle detection range and balance detection the leader 650 and obstacles. Besides, formation tracking and collision avoidance with the detected obstacles are achieved simultaneously.

### Vision-Based Formation Tracking in Obstacle-Free Environments

### Visual Kinematics of Leader-Following Formation

Various example embodiments seek to address the above-mentioned Statement (1) of the leader-following formation tracking control problem, where mobile robots operate in obstacle-free environments. In such a scenario, camera rotation and depth images are not needed. Based on φ_{c}=0 and Equations (4) and (7), there exists:

$${p}_{f} = \frac{u - {u}_{0}}{{α}_{u}} , {q}_{f} = \frac{v - {v}_{0}}{{α}_{v}} \qquad ( Equation 9 )$$

By considering the visibility constraints in Equation (6), the maximum pₘₐₓ and minimum pₘᵢₙ of p_{f} without camera rotation are obtained as

$${p}_{max} = \frac{{u}_{max} - {u}_{0}}{{α}_{u}} and {p}_{min} = \frac{- {u}_{0}}{{α}_{u}} .$$

As for q_{f}, its sign remains unchanged once the height Zₗ is determined. Specifically, q_{f} is always negative if Zₗ>0, and its extreme values are

$${q}_{min} = \frac{- {v}_{0}}{{α}_{v}}$$

and qₘₐₓ=0. For the situation Zₗ<0,

$${q}_{min} = 0 and {q}_{max} = \frac{{v}_{max} - {v}_{0}}{{α}_{v}} .$$

Then, the derivatives of p_{f} and q_{f} may be obtained as:

$${\dot{p}}_{f} = \frac{{}^{s} \dot{X}}{{}^{s} Z} - {p}_{f} \frac{{}^{s} \dot{Z}}{{}^{s} Z} \qquad ( Equation 10 )$$

$${\dot{q}}_{f} = \frac{{}^{s} \dot{Y}}{{}^{s} Z} - {q}_{f} \frac{{}^{s} \dot{Z}}{{}^{s} Z}$$

where ^{s}\dot{X}=−\dot{y}_{lf}, ^{s}\dot{Y}=−Żₗ=0 and ^{s}Ż=\dot{x}_{lf} according to the definition of ^{s}P. On the basis of Equation (3), the following equation may be obtained:

$$\{ \begin{matrix}{}^{s} \dot{X} = - {τ}_{l} sin {θ}_{lf} + {x}_{lf} {ω}_{f} \\ {}^{s} \dot{Y} = 0 \\ {}^{s} \dot{Z} = {τ}_{l} cos {θ}_{lf} - {τ}_{lf} + {y}_{lf} {ω}_{f}\end{matrix} \qquad ( Equation 11 )$$

Next, substituting Equation (11) into Equation (10) and substituting ^{s}Z with

$${}^{s} Z = {x}_{lf} = - \frac{{Z}_{l}}{{q}_{f}}$$

based on Equation (7), the following equation may be obtain:

$${\dot{p}}_{f} = \frac{{p}_{f} {q}_{f}}{{Z}_{l}} {τ}_{f} + ( 1 + {p}_{f}^{2} ) {ω}_{f} - \frac{{τ}_{l}}{{Z}_{l}} ( {q}_{f} sin {θ}_{lf} + {p}_{f} {q}_{f} cos {θ}_{lf} ) \qquad ( Equation 12 )$$

$${\dot{q}}_{f} = \frac{{q}_{f}^{2}}{{Z}_{l}} {τ}_{f} + {p}_{f} {q}_{f} {ω}_{f} - \frac{{τ}_{l}}{{Z}_{l}} {q}_{f}^{2} cos {θ}_{lf}$$

which can be simplified as [\dot{p}_{f}, \dot{q}_{f}]^{T}=G[τ_{f}, ω_{f}]^{T}−h, with

$$G = [ \begin{matrix}\frac{{p}_{f} {q}_{f}}{{Z}_{l}} & 1 + {p}_{f}^{2} \\ \frac{{q}_{f}^{2}}{{Z}_{l}} & {p}_{f} {q}_{f}\end{matrix} ] , h = [ \begin{matrix}\frac{{τ}_{l} {q}_{f}}{{Z}_{l}} ( sin {θ}_{lf} + {p}_{f} cos {θ}_{lf} ) \\ \frac{{τ}_{l}}{{Z}_{l}} {q}_{f}^{2} cos {θ}_{lf}\end{matrix} ]$$

To facilitate the design of the controller according to various example embodiments, the following assumptions and lemmas are presented.

Assumption 1: The velocities of the leader 650 are bounded by |τₗ|≤τ̅ₗ and |ωₗ|≤ω̅ₗ. The follower 610 cannot attain the specific values of τₗ and ωₗ, but knows τ̅ₗ and ω̅ₗ.

Assumption 2: The height Zₗ of P is known to the follower. If the pixel coordinate (u, v) is located in the image plane, the feature P can be detected by the follower 610.

Lemma 1: For x∈ [symbol] −{0}, there exists

$$F ( x ) = \vert erf ( x ) \vert + \frac{λ}{\vert x \vert} > 1 \qquad ( Equation 13 )$$

where

$$λ = \frac{2}{\sqrt[e]{π}} \approx 0.415 and erf ( x ) = \frac{2}{\sqrt{π}} {\int }_{0}^{x} {e}^{- {t}^{2}} dt$$

with |erf(x)|≤1.

Proof: When x>0, the derivative of F(x) is

$$\dot{F} ( x ) = \frac{2}{\sqrt{π}} ( {e}^{- {x}^{2}} ) - \frac{λ}{{x}^{2}} = \frac{2}{\sqrt{π}} ( {e}^{- {x}^{2}} - \frac{1}{{e}^{{x}^{2}}} ) \qquad ( Equation 14 )$$

### Define

$$G ( x ) = {x}^{2} {e}^{- {x}^{2}} - \frac{1}{e} ,$$

there exists

$$\dot{F} ( x ) = \frac{2}{\sqrt{π} {x}^{2}} G ( x ) .$$

The derivative G(x) is Ġ(x)=2xe^{-x}^{²}(1−x²), which implies that x=0, 1, −1 are critical points. To obtain extreme values of G(x), the values of \ddot{G}(x) at critical points are calculated as \ddot{G}(0)=2 and

$$\ddot{G} ( - 1 ) = \ddot{G} ( 1 ) = - \frac{4}{e} .$$

Therefore, the function G(x) has the minimum value

$$G ( 0 ) = - \frac{1}{e}$$

and the maximum values G(1)=G(−1)=0. Then, we obtain that \dot{F}(x)≤0 and the function F(x) is decreasing when x>0. Thus, for any x∈(0, +∞), F(x)>F(+∞)=1. Similarly, when x<0, the function becomes

$$F ( x ) = - erf ( x ) - \frac{λ}{x} ,$$

whose derivative satisfies \dot{F}(x)≥0. Thus, F(x) is increasing and F(x)≥F(−∞)=1. The proof is done.

### Controller Design

In this section, a controller is designed to achieve formation tracking described in the above-mentioned Statement (1) of the leader-following formation tracking control problem, that is, a controller for an obstacle-free environment. To facilitate visibility maintenance without camera rotation, according to various example embodiments, two potential functions Ψₚ and Ψ_{q} are introduced to describe the constraints for p_{f} and q_{f} respectively, which may be expressed as:

$${Ψ}_{p} = \{ \begin{matrix}{\overline{p} ( \frac{{p}_{f} - {p}_{d} )}{{p}_{d} - {p}_{m i n}} )}^{2} & {p}_{f} ∈ [ {p}_{m i n} , {p}_{d} ] \\ \overline{p} {( \frac{{p}_{f} - {p}_{d} )}{{p}_{d} - {p}_{ma x}} )}^{2} & {p}_{f} ∈ [ {p}_{d} , {p}_{ma x} ]\end{matrix} \qquad ( Equation 15 )$$

$${Ψ}_{q} = \{ \begin{matrix}{\overline{q} ( \frac{{q}_{f} - {q}_{d} )}{{q}_{d} - {q}_{m i n}} )}^{2} & {q}_{f} ∈ [ {q}_{m i n} , {q}_{d} ] \\ \overline{q} {( \frac{{q}_{f} - {q}_{d} )}{{q}_{d} - {q}_{ma x}} )}^{2} & {q}_{f} ∈ [ {q}_{d} , {q}_{ma x} ]\end{matrix} \qquad ( Equation 16 )$$

where p̅ and q̅ are the amplitudes of Ψₚ and Ψ_{q} relatively. It can be understood that Ψₚ has only one minimum 0 at the desired value p_{d}, which is differentiable at this minimum point. Besides, its values at pₘₐₓ and pₘᵢₙ are both equal to p̅, allowing it to have a proper decreasing rate on both sides of p_{d}. Similar results also hold for Ψ_{q}. Accordingly, the two potential functions Ψₚ and Ψ_{q} are configured to have boundaries which correspond to boundaries of the image plane of the follower camera 620 and to have a minimum (e.g., 0) when the detected pixel coordinates match the desired pixel coordinates for tracking the leader 650. Therefore, the two potential functions Ψₚ and Ψ_{q} seek to keep the detected pixel coordinates within the boundaries of the image plane of the follower camera 620 and approach the desired pixel coordinates for tracking the leader 650 as close as possible.

Based on Ψₚ and Ψ_{q}, an example controller for solving the above-mentioned Statement (1) of the leader-following formation tracking control problem may be developed as follows:

$$[ \begin{matrix}{τ}_{f}^{s} \\ {ω}_{f}^{s}\end{matrix} ] = - Q ( [ \begin{matrix}{k}_{p} {φ}_{p} \\ {k}_{q} {φ}_{q}\end{matrix} ] + [ \begin{matrix}{δ}_{p} erf ( \frac{{δ}_{p} {Ψ}_{p}}{{γ}_{p} {φ}_{p} )} \\ {δ}_{q} erf ( \frac{{δ}_{q} {Ψ}_{q}}{{γ}_{q} {φ}_{q}} )\end{matrix} ] ) \qquad ( Equation 17 )$$

where φₚ=p_{f}−p_{d}, φ_{q}=q_{f}−q_{d} can be regarded as feedback control laws in the pixel space and kₚ, k_{q} are corresponding gains. In Equation (17), the first term Q corresponds to a transformation matrix configured for transforming from the pixel space to the Cartesian space, the second term corresponds to a feedback control rate for minimizing the potential function and the third term is configured to remove the effect of unknown leader velocity. However, various example embodiments note that the unknown vector h in visual kinematics due to unknown leader velocities can have negative effects on the control performance. To address this issue, a vector ω is designed as

$$ω = {[ {δ}_{p} erf ( \frac{{δ}_{p} {Ψ}_{p}}{{γ}_{p} {φ}_{p}} ) , {δ}_{q} erf ( \frac{{δ}_{q} {Ψ}_{q}}{{γ}_{q} {φ}_{q}} ) ]}^{T} ,$$

where

$${δ}_{p} = \frac{{\overline{τ}}_{l} {\hat{q}}_{f}^{m ax} ( 1 + {\hat{p}}_{m ax} )}{\vert {z}_{l} \vert} , {δ}_{q} = \frac{{\overline{τ}}_{l} {\hat{q}}_{m ax}^{2}}{\vert {z}_{l} \vert}$$

are the upper bounds of elements in h and

$${\hat{p}}_{ma x} = max \{ \frac{{u}_{0}}{{α}_{u}} , \frac{{u}_{m ax} - {u}_{0}}{{α}_{u}} \} , {\hat{q}}_{ma x} = max \{ \frac{{v}_{0}}{{α}_{v}} , \frac{{v}_{ma x} - {v}_{0}}{{α}_{u}} \}$$

are the maximum values of |p_{f}| and |q_{f}|, respectively. The function erf(x) is introduced to estimate the magnitude of negative effects caused by h and γₚ, γ_{q} are positive constants used to adjust the estimation precision. Accordingly, the vector ω has two components, whereby the first term is the corresponding maximum value and the second term is the specific magnitude. The interference due to the unknown leader velocity must lie within the maximum value but the magnitude of the interference is unknown because it is related to the instantaneous speed of the leader. In this regard, the magnitude function of the second term is to estimate this unknown magnitude of the interference. Then, to transfer the velocity from the pixel space to the robot space, the matrix Q=G⁻¹ is applied.

Based on the above-mentioned Lemma 1 and the controller according to Equation (17), the following theorem may be provided.

Consider a leader-following formation in an obstacle-free environment, where the feature P locates in the image plane of the follower camera initially. If the follower executes the control law

$${τ}_{f} = {τ}_{f}^{s} ,$$

$${ω}_{f} = {ω}_{f}^{s}$$

and satisfies parameter conditions

$$\sqrt{\frac{{λγ}_{p}}{{k}_{p} \overline{p}}} < 1 , \sqrt{\frac{{λγ}_{q}}{{k}_{q} \overline{q}}} < 1 ,$$

then the above-mentioned Statement (1) of the leader-following formation tracking control problem will hold under the above-mentioned Assumption 1 and 2.

Proof: To analyze the stability of the system, two Lyapunov candidate functions may be chosen for p_{f} and q_{f} as

$${V}_{p} = \frac{1}{2} {Ψ}_{p} and {V}_{q} = \frac{1}{2} {Ψ}_{q} ,$$

respectively. Taking the derivatives of these functions using Equations (12), (15), and (16), the following equation may be obtained:

$$[ \begin{matrix}{\dot{V}}_{p} \\ {\dot{V}}_{q}\end{matrix} ] [ \begin{matrix}\frac{{Ψ}_{p}}{{p}_{f} - {p}_{d}} & 0 \\ 0 & \frac{{Ψ}_{q}}{{q}_{f} - {q}_{d}}\end{matrix} ] ( [ \begin{matrix}\frac{{p}_{f} {q}_{f}}{{Z}_{l}} & 1 + {p}_{f}^{2} \\ \frac{{q}_{f}^{2}}{{Z}_{l}} & {p}_{f} {q}_{f}\end{matrix} ] [ \begin{matrix}{τ}_{f}^{s} \\ {ω}_{f}^{s}\end{matrix} ] + [ \begin{matrix}- \frac{{τ}_{l}}{{Z}_{l}} ( {q}_{f} sin {θ}_{lf} + {p}_{f} {q}_{f} cos {θ}_{lf} ) \\ - \frac{{τ}_{l}}{{Z}_{l}} {q}_{f}^{2} cos {θ}_{lf}\end{matrix} ] ) = - [ \begin{matrix}{k}_{p} {Ψ}_{p} \\ {k}_{q} {Ψ}_{q}\end{matrix} ] - [ \begin{matrix}\frac{{δ}_{p} {Ψ}_{p}}{{p}_{f} - {p}_{d}} erf ( \frac{{δ}_{p} {Ψ}_{p}}{{γ}_{p} ( {p}_{f} - {p}_{d} )} ) \\ \frac{{δ}_{q} {Ψ}_{q}}{{q}_{f} - {q}_{d}} erf ( \frac{{δ}_{q} {Ψ}_{q}}{{γ}_{q} ( {q}_{f} - {q}_{d} )} )\end{matrix} ] - [ \begin{matrix}- \frac{{τ}_{l} {Ψ}_{p}}{{Z}_{l} ( {p}_{f} - {p}_{d} )} ( {q}_{f} sin {θ}_{lf} + {p}_{f} {q}_{f} cos {θ}_{lf} ) \\ - \frac{{τ}_{l} {Ψ}_{q}}{{Z}_{l} ( {q}_{f} - {q}_{d} )} {q}_{f}^{2} cos {θ}_{lf}\end{matrix} ] \qquad ( Equation 18 )$$

Define the auxiliary function as

$${R}_{γ} ( x ) = \vert x \vert - ( \frac{x}{γ} ) ,$$

where γ>0 represents a positive adjustable parameter and there exists:

$$\vert {R}_{γ} ( x ) \vert = \vert x \vert \vert - x erf ( \frac{x}{γ} ) \vert = \vert x \vert ( 1 - \vert erf ( \frac{x}{γ} ) \vert ) < \vert x \vert λ \vert \frac{γ}{x} \vert = λγ$$

based on Lemma 1. Then, for \dot{V}_{q}, the following equation may be obtained:

$${\dot{V}}_{q} \leq - {k}_{q} {Ψ}_{q} - \frac{{δ}_{q} {Ψ}_{q}}{{q}_{f} - {q}_{d}} erf ( \frac{{δ}_{q} {Ψ}_{q}}{{γ}_{q} ( {q}_{f} - {q}_{d} )} ) + \vert \frac{{\overline{τ}}_{l} {Ψ}_{q} {\hat{q}}_{m ax}^{2}}{\vert {Z}_{l} ( {q}_{f} - {q}_{d} ) \vert} \vert \leq - {k}_{q} {Ψ}_{q} + \vert \frac{{δ}_{q} {Ψ}_{q}}{{q}_{f} - {q}_{d}} \vert - \frac{{δ}_{q} {Ψ}_{q}}{{q}_{f} - {q}_{d}} erf ( \frac{{δ}_{q} {Ψ}_{q}}{{γ}_{q} ( {q}_{f} - {q}_{d} )} ) \leq - {k}_{q} {Ψ}_{q} + \vert {R}_{{γ}_{q}} \frac{{δ}_{q} {Ψ}_{q}}{{q}_{f} - {q}_{d}} \vert \leq - {k}_{q} {V}_{q} + λ {γ}_{q} \qquad ( Equation 19 )$$

Therefore, it can be found that:

$${V}_{q} ( t ) \leq \frac{λ {γ}_{q}}{{k}_{q}} + ( {V}_{q} ( 0 ) - \frac{λ {γ}_{q}}{{k}_{q}} ) {e}^{- {k}_{q}^{t}} \qquad ( Equation 20 )$$

which implies that V_{q}(t) finally converges to

$$\{ {V}_{q} \vert {V}_{q} \leq \frac{λ {γ}_{q}}{{k}_{q}} \} .$$

Thus, the variable q_{f} finally drops into the set

$${Ω}_{q} = \{ {q}_{f} \vert ( 1 - \sqrt{\frac{λ {γ}_{q}}{{k}_{q} \overline{q}}} ) {q}_{d} + {q}_{min} \sqrt{\frac{λ {γ}_{q}}{{k}_{q} \overline{q}}} \leq {q}_{f} \leq ( 1 - \sqrt{\frac{λ {γ}_{q}}{{k}_{q} \overline{q}}} ) {q}_{q} + {q}_{max} \sqrt{\frac{λ {γ}_{q}}{{k}_{q} \overline{q}}} \} .$$

### When

$$\sqrt{\frac{λ {γ}_{q}}{{k}_{q} \overline{q}}} < 1 ,$$

the set Ω_{q} is a subset of (qₘᵢₙ, qₘₐₓ).

Since the feature P is on the image plane of the follower camera 620 initially, the value of q_{f}(0) belongs to (qₘᵢₙ, qₘₐₓ). Based on Equation (20), q_{f} will converge to Ω_{q} from q_{f}(0), and thus, it always remains in (qₘᵢₙ, qₘₐₓ).

Similarly, the derivative of the Lyapunov function Vₚ satisfies:

$${\dot{V}}_{p} \leq - {k}_{p} {Ψ}_{p} - \frac{{δ}_{p} {Ψ}_{p}}{{p}_{f} - {p}_{d}} erf ( \frac{{δ}_{p} {Ψ}_{p}}{{γ}_{p} ( {p}_{f} - {p}_{d} )} ) - \frac{{τ}_{l} {Ψ}_{p}}{{Z}_{l} ( {p}_{f} - {p}_{d} )} ( {q}_{f} sin {θ}_{lf} + {p}_{f} {q}_{f} cos {θ}_{lf} ) \qquad ( Equation 21 )$$

$$\leq - {k}_{p} {Ψ}_{p} - \frac{{δ}_{p} {Ψ}_{p}}{{p}_{f} - {p}_{d}} erf ( \frac{{δ}_{p} {Ψ}_{p}}{{γ}_{p} ( {p}_{f} - {p}_{d} )} ) + \vert \frac{{δ}_{p} {Ψ}_{p}}{{p}_{f} - {p}_{d}} \vert$$

$$\leq - {k}_{p} {Ψ}_{p} + \vert {R}_{{γ}_{p}} \frac{{δ}_{p} {Ψ}_{p}}{{p}_{f} - {p}_{d}} \vert \leq - {k}_{p} {V}_{p} + λ {γ}_{p}$$

Likely, the pixel p_{f} will converge to the set

$${Ω}_{p} = \{ {p}_{f} \vert ( 1 - \sqrt{\frac{λ {γ}_{p}}{{k}_{p} \overline{p}}} ) {p}_{d} + {p}_{min} \sqrt{\frac{λ {γ}_{p}}{{k}_{p} \overline{p}}} \leq {p}_{f} \leq ( 1 - \sqrt{\frac{λ {γ}_{p}}{{k}_{p} \overline{p}}} ) {p}_{d} + {p}_{max} \sqrt{\frac{λ {γ}_{p}}{{k}_{p} \overline{p}}} \} .$$

The set Ωₚ belongs to (pₘᵢₙ, pₘₐₓ), if

$$\sqrt{\frac{λ {γ}_{p}}{{k}_{p} \overline{p}}} < 1 .$$

As the initial value of p_{f} satisfies p_{f}(0)∈(pₘᵢₙ, pₘₐₓ), p_{f} will always remain in the range (pₘᵢₙ, pₘₐₓ).

Hence, according to the navigation control input

$$( {τ}_{f}^{s} and {ω}_{f}^{s} )$$

determined according to the above-described example controller for formation tracking in an obstacle-free environment, the variables p_{f} and q_{f} always remain within the image plane of the follower camera 620 if the feature P is visible initially. Moreover, they finally converge to the neighbourhood of Ωₚ and Ω_{q}. The size of these neighbourhoods can be adjusted by tuning the values of the parameters kₚ, k_{q}, γₚ, and γ_{q}. For example, increasing kₚ and k_{q} results in smaller neighbourhoods, while increasing γₚ and γ_{q} yields larger ones. However, when kₚ, k_{q} are too small or γₚ, γ_{q} are too large, the robot velocities will be too large and vary drastically, so the parameters are chosen appropriately.

For the above-mentioned Assumptions 1 and 2, various example embodiments found that if the upper bounds of leader velocities in Assumption 1 are unknown, one option is to remove τ̅ₗ from the control laws and gradually adjust the parameters kₚ, k_{q}, γₚ, and γ_{q} to offset the negative effects of the unknown leader velocities. In the case of Assumption 2, various example embodiments found that color images can be used to sample the leader feature at different positions and estimate Zₗ in advance, or use depth images to directly calculate Zₗ, or apply adaptive control laws to dynamically estimate Zₗ.

Formation Tracking in Obstacle Environments with Rotating Camera

Various example embodiments seek to address the above-mentioned Statement (2) of the leader-following formation tracking control problem by developing a method or strategy for achieving leader-following formation tracking in obstacle environments using only an RGB-D camera on the follower ground robot for feedback of the surrounding environment. In this regard, various example embodiments provide a camera rotation method or strategy for the follower camera 620 configured to serve three purposes: 1) maintaining visibility of the leader 650, 2) enlarging the obstacle detection range, and 3) balancing the detection of the leader 650 and obstacles. Based on the above-described controller configured for an obstacle-free environment, various example embodiments configure a multi-objective controller that enables the follower 610 to achieve both formation tracking and obstacle avoidance, using only an RGB-D camera 620 on the follower ground robot 610 for feedback of the surrounding environment, without the need for communication or knowledge of the leader's velocity.

### Camera Rotation Method for Obstacle Environments

In various example embodiments, each scene point may be defined as pₒ=(ρₒ, θₒ, tₒ) and the scene point set may be expressed as Θ_{f}={pₒ|θₒ∈[θₘᵢₙ, θₘₐₓ], θₒ=θₘᵢₙ+k^{θ}Δθ, k^{θ}∈ [symbol] to record nearby obstacles of the follower 610. ρₒ denotes the relative distance to the scene portion (which may be an obstacle portion) in the θₒ direction with respect to the follower 610. When the θₒ direction is undetected (unexplored), ρₒ may be set as −1. Furthermore, θₘᵢₙ, θₘₐₓ, and Δθ denote the minimum, maximum, and the sampling step of θₒ, while tₒ denotes the time when pₒ is recorded. For example, θₘᵢₙ and θₘₐₓ may be set to around −π/2 and π/2, since the follower 610 usually moves forward to track the leader 650 and thus obstacles behind the follower 610 are typically not relevant. Accordingly, the scene point set may be an angle-indexing set which discretize the surrounding area with respect to angles (relative angle between the follower robot 610 and the scene portion). In various example embodiments, each scene point may correspond to the position of the scene portion at the pixel point in the current frame of the follower robot 610 and may have associated therewith a relative distance and a relative angle between the follower robot 610 and the scene portion (e.g., may be an obstacle portion of an obstacle).

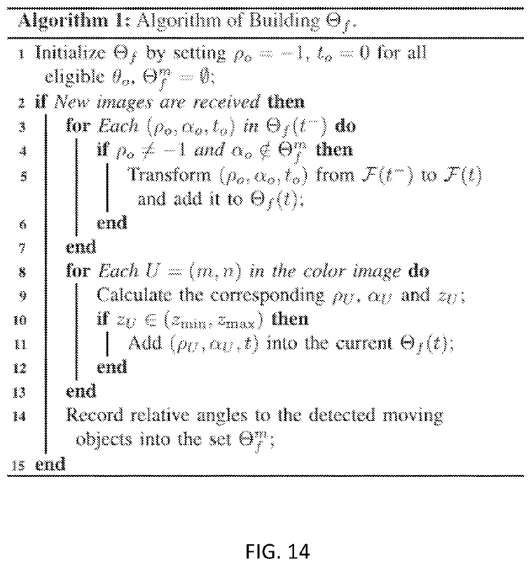

FIG. 14 shows an example method (or an algorithm referred to herein as Algorithm 1) for constructing a scene point set Θ_{f} according to various example embodiments of the present invention (e.g., corresponding to the determining (at 108) a scene point set based on the current color image and the associated depth information as described hereinbefore according to various embodiments of the invention). To construct the scene point set Θ_{f}, the example method may first initialize it by setting all scene points as undetected. Then, when the follower camera 620 captures a new image, the example method may update the scene points in the scene point set Θ_{f} by transforming them from the follower frame [symbol] (t⁻) at the time of the last (immediately previous) image reception to the current frame [symbol] (t). In this regard, dynamic obstacles and undetected areas do not need to be transformed. After the transformation, for each pixel point U=(m, n) in the color image, its position p_{U}=(x_{U}, y_{U}, z_{U}) in the current follower frame [symbol] (t) may be determined using Equations (4) and (5) as follows:

$$\{ \begin{matrix}{x}_{U} & = {d}_{U} sin {φ}_{c} \frac{m - {u}_{0}}{{α}_{u}} + cos {φ}_{c} {d}_{U} \\ {y}_{U} & = - {d}_{U} cos {φ}_{c} \frac{m - {u}_{0}}{{α}_{u}} + sin {φ}_{c} {d}_{U} \\ {z}_{U} & = {d}_{U} \frac{n - {v}_{0}}{{α}_{v}}\end{matrix} \qquad ( Equation 22 )$$

where d_{U} is the corresponding depth of U in the depth image. Defining the relative distance and angle as

$${ρ}_{U} = \sqrt{{x}_{U}^{2} + {y}_{U}^{2}} and {α}_{U} = ( \frac{{y}_{U}}{{x}_{U}} ) ,$$

respectively, the following equation may be obtained:

$${ρ}_{U} = {d}_{U} \sqrt{1 + {( \frac{m - {u}_{0}}{{α}_{u}} )}^{2}} , {α}_{U} = atan ( {θ}_{U} + {φ}_{c} ) \qquad ( Equation 23 )$$

where

$${θ}_{U} = atan ( \frac{m - {u}_{0}}{{α}_{u}} ) .$$

When z_{U}∈(zₘᵢₙ, zₘₐₓ), the corresponding scene point (ρ_{U}, α_{U}, t) (e.g., may be an obstacle point) may be added into the scene point set Θ_{f}, where zₘₐₓ and zₘᵢₙ are set to exclude points on the ceiling and floor, respectively. Finally, the relative angles of dynamic obstacles may be recorded into

$${Θ}_{f}^{m}$$

for reference, assuming that all dynamic obstacles can be detected. In this manner, the scene point set Θ_{f} is constructed until all pixel points in the image are visited or processed.

Based on the scene point set Θ_{f} determined, a camera rotation method or strategy is developed according to various example embodiments of the present invention (e.g., corresponding to the determining (at 112) a sensing direction control input as described hereinbefore according to various embodiments of the present invention). The camera rotation method is configured to determine the rotation direction (i.e., sensing direction) of the follower camera based on a number of objectives or factors, including 1) tracking the feature P on the leader 650 (a leader tracking factor), 2) detecting the previously undetected area (an area/environment exploration factor), 3) following dynamic obstacles (a dynamic obstacle tracking factor), and 4) resisting drastic changes in the camera rotation angle (a large camera rotation avoidance factor). To achieve these objectives, functions are designed to define the objectives, respectively, and a camera rotation method or strategy is developed based on these functions.

In various example embodiments, a first function g₁(β) may be defined based on the leader tracking factor for the leader tracking. In this regard, the leader tracking factor function may be configured to output a leader tracking factor value dependent on a sensor direction variable β, the leader tracking factor value providing a measure of tracking of the leader 650 with respect to the FOV of the follow camera 620 for a sensor direction. As an illustrative example, an example first function g₁(β) may be expressed as follows:

$${g}_{1} ( β ) = G ( β - {α}_{lf} ) , G ( θ ) = \{ \begin{matrix}0 & ( \vert θ \vert \leq {θ}_{h} ) \\ {θ}^{2} - {θ}_{h}^{2} & ( else )\end{matrix} \qquad ( Equation 24 )$$

where α_{lf}=−atan(p_{f}) corresponds to the relative angle to the leader in the follower frame [symbol] , β represents the camera rotation angle variable (or sensor direction variable) to be optimized and θₕ is a predetermined angle threshold. For example, according to the example first function g₁(β), when the pixel coordinates of the leader 650 is more than the predetermined angle threshold θₕ away from the center axis of the camera image, the camera triggers a rotation to track the leader 650 such that the leader 650 is within the predetermined angle threshold θₕ. For example, when the pixel coordinates of the leader 650 is within the predetermined angle threshold θₕ, the pixel coordinates of the leader 650 is sufficiently near the center axis of the of the camera image and thus no rotation of the camera 620 is required to track the leader 650.

In various example embodiments, a second function g₂(β) may be defined based on the area/environment exploration factor for guiding the follower camera 620 to the undetected area. In this regard, the area exploration factor function configured to output an area obstacle exploration factor value dependent on the sensor direction variable (β), the area obstacle exploration factor value providing a measure of a degree of sensor obstacle exploration of an area associated with a sensor direction. As an illustrative example, an example second function g₂(β) may be expressed as g₂(β)=(β−φ)², whereby the angle φ is a time-weighted average of θₒ and may be defined as:

$$ϕ = {g}_{l} \frac{{\sum }_{{p}_{o} ∈ {ϒ}_{f}^{l}} ( t - {t}_{o} ) {θ}_{o}}{{\sum }_{{p}_{o} ∈ {ϒ}_{f}^{l}} ( t - {t}_{o} )} + ( 1 - {g}_{l} ) \frac{{\sum }_{{p}_{o} ∈ {ϒ}_{f}^{r}} ( t - {t}_{o} ) {θ}_{o}}{{\sum }_{{p}_{o} ∈ {ϒ}_{f}^{r}} ( t - {t}_{o} )}$$

where

$${Υ}_{f}^{l} = \{ {p}_{o} \vert {p}_{o} ∈ {Θ}_{f} , {θ}_{o} \geq 0 , t - {t}_{o} \geq {t}_{h} \}$$

is the set containing scene points which have not been updated for more than tₕ on the left side,

$${Υ}_{f}^{r} = \{ {p}_{o} \vert {p}_{o} ∈ {Θ}_{f} , {θ}_{o} < 0 , t - {t}_{o} \geq {t}_{h} \}$$

is the similar scene point set on the right side. The parameter tₕ is designed to discard all observations obtained before (t−tₕ) in the scene point set Θ_{f}, which helps Θ_{f} to update data in time and become robust to environment changes. The variable gₗ is equal to 1 when

$$card ( {ϒ}_{f}^{l} ) \geq card ( {ϒ}_{f}^{γ} )$$

and 0 otherwise, where card(A) is the number of elements in set A. The environment exploration rate eᵢ for the follower i may be defined as

$${e}_{i} = \frac{card ( {E}_{f} )}{card ( {Θ}_{f} )} ,$$

where the explored set E_{f} is E_{f}={pₒ|pₒ∈Θ_{f}, pₒ>0, t−tₒ<tₕ}. In various example embodiments, the scene point set Θ_{f} may be divided into the left and the right regions as described hereinbefore. Accordingly, the second function g₂(β) may be configured to determine which side has more unexplored area and attempts to turn the camera 620 towards that side. In this regard, the sensor direction variable (β) may be determined based on the weighted average of all angles corresponding to all unexplored areas with respect to unexplored time. Therefore, the longer the time an angle remains unexplored, the more the second function g₂(β) may be configured to seek to turn the camera 620 towards that angle. In various example embodiments, an associated advantage is that the camera 620 can be prevented from stopping rotating when the undetected areas on the left and right sides are approximately equal.

In various example embodiments, a third function g₃(β) may be defined based on the dynamic obstacle tracking factor for tracking dynamic obstacles. In this regard, the dynamic obstacle tracking factor function may be configured to output a dynamic obstacle tracking factor value dependent on the sensor direction variable, the dynamic obstacle tracking factor value providing a measure of tracking of one or more moving obstacles with respect to the field of view of the depth sensor for a sensor direction. As an illustrative example, an example third function may be expressed as:

$${g}_{3} ( β ) = {\sum }_{i = 1}^{N} {ω}_{f i} G ( β - {α}_{f i} ) \qquad ( Equation 25 )$$

where N is the number of moving obstacles,

$${ω}_{fi} = \frac{\vert {v}_{fi}^{t} \vert}{\vert {p}_{fi} \vert}$$

is the relative angular velocity of obstacle i around the follower, p_{fi} and α_{fi} are the position and the angle of obstacle i in [symbol] ,

$${v}_{fi}^{t}$$

is the tangential component of relative velocity v_{fi} with respect to obstacle i, where v_{fi} is estimated by the difference of p_{fi} at sampled instants. Besides, g₃(β) is 0 when N=0. For example, the example third function g₃(β) seeks to track all moving obstacles and the direction of tracking is weighted average according to their speed away (ω_{fi}) from the camera's field of view.

In various example embodiments, a fourth function g₄(β) may be defined based on the large camera rotation avoidance factor for resisting abrupt or large changes in the camera rotation angle (sensing direction) φ_{c}. In this regard, the large sensor rotation avoidance factor function may be configured to output a large sensor rotation avoidance factor value dependent on the sensor direction variable, the large sensor rotation avoidance factor value providing a measure of a degree of sensor rotation for a sensor direction. As an illustrative example, an example fourth function g₄(β) may be expressed as g₄(β)=(β−φ_{c}(t⁻))², where φ_{c}(t⁻) is the value of φ_{c} at last (immediately previous) sampling instant t⁻. For example, the example fourth function g₄(β) is configured based on the square of the difference between the sensor angle variable (or sensor direction variable) β and the sensor angle at the immediately previous time instance (t⁻). In this regard, the smaller the output of the example fourth function, the closer the angle variable is to the sensor angle at the immediately previous time instance. Accordingly, for this example fourth function, the optimization goal is to make this example fourth function as small as possible, meaning the sensor angle variable β is optimized to be as close as possible to the sensor angle at the immediately previous time instance (or sampling instant), thereby avoiding large or excessive rotation compared to the previous time instance.

In various example embodiments, with the above-mentioned potential functions g₁ to g₄, the overall potential function g(β) (dependent on the camera rotation angle variable (or sensor direction variable) β) and the desired obstacle avoidance angle

$${φ}_{c}^{d}$$

of φ_{c} may be obtained as follows by optimizing the overall potential function with respect to the camera rotation angle variable β:

$$g ( β ) = {\sum }_{i = 1}^{4} {λ}_{i} {g}_{i} ( β ) \qquad ( Equation 26 )$$

$${φ}_{c}^{d} = {arg}_{β} min g ( β )$$

where λᵢ is the weighting parameter for gᵢ and

$${\sum }_{i = 1}^{4} {λ}_{i} = 1 .$$

In various example embodiments, in cases where the feature P of the leader 650 is lost by accident (e.g., due to obstruction or sudden changes in illumination), the camera 620 may be controlled to quickly rotate to the direction in which the feature P appeared last time with λ₁=1 and λᵢ=0 (i≠1).

With the desired obstacle avoidance angle

$${φ}_{c}^{d} ,$$

the angular velocity of the rotatable camera 620 may then be determined as

$${ω}_{c} = {k}_{c} ( {φ}_{c} - {φ}_{c}^{d} )$$

with k_{c} as the proportional gain.

According to various example embodiments, it is assumed that the camera rotation speed is fast enough compared to the robot motion speed and ω_{fi} of dynamic obstacles, which means that all detection tasks can be achieved on time. Moreover, the approach according to various example embodiments is space and time efficient compared to SLAM and mapping-based methods, which can better meet the requirements of real-time control and adapt to dynamic obstacles.

### Obstacle Avoidance Strategy in Formation Tracking

In various example embodiments, to achieve obstacle avoidance and formation tracking, a multi-objective controller is provided based on the above-described controller configured for an obstacle-free environment. In this regard, the minimum distance to the detected obstacles (i.e., distance to the closest detected obstacle portion(s)) may be defined as d_{fo}=min{pₒ|(ρₒ, θₒ, tₒ)∈Θ_{f}, ρₒ>0, t−tₒ<tₕ} and the corresponding relative angle θₒ of d_{fo} may be defined as α_{fo}. If there are multiple d_{fo} with the same value, all of them may be recorded instead of just one. An objective of the obstacle avoidance is to seek to maintain d_{fo} to be always no lower than the safe distance threshold dₛ.

For example, as shown in FIG. 9, the available angle set

$${Θ}_{f}^{a}$$

for obstacle avoidance with a distance threshold dₒ may be defined as:

$${Θ}_{f}^{a} = \{ {θ}_{o} \vert ( {ρ}_{o} , {θ}_{o} , {t}_{o} ) ∈ {Θ}_{f} , {ρ}_{o} \geq {d}_{o} , t - {t}_{o} < {t}_{h} \} \qquad ( Equation 27 )$$

where ρₒ≥dₒ is a predetermined distance threshold condition. Accordingly, the available navigation direction set

$${Θ}_{f}^{a}$$

comprises available navigation directions θₒ determined based on scene points in the scene point set Θ_{f} which have associated therewith the relative distance ρₒ between the follower ground robot and the scene portion satisfying a predetermined distance threshold condition (ρₒ≥dₒ).

However, various example embodiments note that the scene point set

$${Θ}_{f}^{a}$$

may be improved for obstacle avoidance, because it may contain various boundary points of obstacles. For example, the follower 610 itself occupies certain volume and the edges of the obstacles may not be accurately observed. Accordingly, various example embodiments seek to process the scene point set by filtering out these edge points, leaving a safer area to make obstacle avoidance more secure and smooth. To make the follower safer in obstacle environments, in various example embodiments, an erosion operation is performed on the scene point set

$${Θ}_{f}^{a} ,$$

which may be expressed as:

$${\tilde{Θ}}_{f}^{a} = {Θ}_{f}^{a} ⊖ B = \{ θ \vert {( B )}_{θ} ⊆ {Θ}_{f}^{a} \} \qquad ( Equation 28 )$$

where ⊖ is the erosion operator for eliminating edges of a set, (B)_{θ} is the translation of B defined as (B)_{θ}={b+θ|b∈B}, B={iΔθ|i∈ [symbol] , |i|≤k} and

$${\tilde{Θ}}_{f}^{a}$$

is the scene point set after erosion, whose size is adjusted by the parameter k in set B. Furthermore, in various example embodiments, when the follower 610 is close to obstacles, i.e.,

$${d}_{fo} \to {d}_{s}^{+} ,$$

a further filtering operation is performed on

$${\tilde{Θ}}_{f}^{a}$$

to remove all elements θ satisfying

$$\vert {α}_{fo} - θ \vert < \frac{π}{2}$$

to ensure the follower 610 is kept away from obstacles. This is because if the angle between the follower's forward direction and an obstacle is less than 90 degrees, then the follower 610 will get closer to the obstacle. On the other hand, when the angle between the obstacle and the follower 610 is greater than 90 degrees, the follower 610 will be moving away from the obstacle. Therefore, for the follower 610 to completely move away from an obstacle, various example embodiments may filter out the scene points in the scene point set where the relative angle with the robot is less than 90 degrees. Accordingly, if the follower 610 moves along an available direction in

$${\tilde{Θ}}_{f}^{a} ,$$

it will avoid collisions with the detected obstacles.

In various example embodiments, to balance the formation tracking task, the obstacle avoidance direction \vec{O_{F}G} is selected to be the same as or near the goal or desired navigation direction \vec{O_{F}E} of formation tracking. Assume the motion direction of the follower as \vec{O_{F}M} and ∠MO_{F}G as

$${α}_{fo}^{d} ,$$

the following equation may be derived:

$${α}_{fo}^{d} = arg {min}_{θ ∈ {\tilde{Θ}}_{f}^{a}} \vert θ - {α}_{lf}^{d} \vert \qquad ( Equation 29 )$$

where

$${α}_{lf}^{d} = ∠ {MO}_{F} E = - a tan ( {p}_{d} ) .$$

Accordingly, Equation (29) seeks to select an available direction (or angle) (corresponding to the desired obstacle avoidance direction) in the available angle (or direction) set

$${\tilde{Θ}}_{f}^{a}$$

that is closest to the desired navigation direction

$${α}_{lf}^{d}$$

determined according to the original formation tracking task under an obstacle-free environment. Therefore, Equation (29) enables obstacle avoidance while still being able to complete the original formation tracking task as close as possible.

Based on the available angle set

$${\tilde{Θ}}_{f}^{a} ,$$

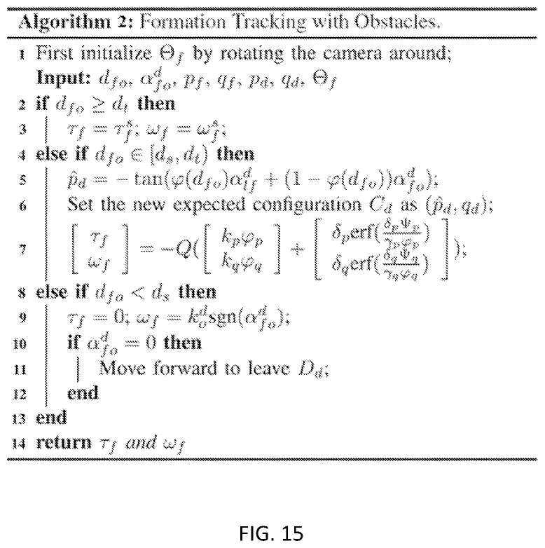

the following Assumption 3 and its corresponding method (or an algorithm referred to herein as Algorithm 2) are provided according to various example embodiments of the present invention. In this regard, FIG. 15 shows an example method (Algorithm 2) for determining the navigation control input (e.g., τ_{f} and ω_{f}) for navigating the follower robot 610 for tracking the leader robot 650 in an obstacle environment according to various example embodiments of the present invention.

Assumption 3: The leader 650 of the entire robot formation can generate a collision-avoidance trajectory with existing navigation methods. For the follower 610, in various example embodiments, three conditions should be met: 1) it can detect all nearby dangerous obstacles (close to dₛ) successfully; 2)

$${\tilde{Θ}}_{f}^{a} \neq ∅ for ∀ t \geq 0 ;$$

3) the condition

$${α}_{lf}^{d} = - a tan ( {p}_{d} ) ∈ {\tilde{Θ}}_{f}^{a} ( t )$$

holds in the steady state and lasts for a sufficiently long time. Besides, all dynamic obstacles are cooperative, meaning that they coordinate collision avoidance rather than get collisions deliberately, just like neighbouring robots with the same obstacle avoidance strategy, and humans.

Assuming Assumption 3 holds, a multi-objective controller according to various example embodiments is configured for the follower 610 under an obstacle environment in Algorithm 2. Based on d_{fo}, the workspace of the follower 610 may be divided into three regions/district, including 1) a safe district Dₛ(d_{fo}≥dₜ), 2) a transition district Dₜ(dₛ≤d_{fo}<dₜ), and 3) a danger district D_{d}(d_{fo}<dₛ). The distance thresholds dₛ and dₜ satisfy dₛ<dₜ≤dₒ.

When the follower 610 is in the safe district Dₛ, the multi-objective controller is configured to control the follower 610 based on

$${τ}_{f}^{s} and {ω}_{f}^{s}$$

as in an obstacle-free environment, with the only difference being that that the function Ψₚ is changed to Ψₚ=p̅(p_{f}−\hat{p}_{d})², as p_{f} is no longer constrained by pₘₐₓ and pₘᵢₙ under camera rotation. In the danger district D_{d}, based on Assumption 3, the follower 610 can observe all nearby dangerous obstacles and the environment is spacious enough such that there always exist elements in

$${\tilde{Θ}}_{f}^{a} ( t ) .$$

It means that the obstacle avoidance direction \vec{O_{F}G} can always be found in

$${\tilde{Θ}}_{f}^{a} ( t ) .$$

With \vec{O_{F}G}, the follower 610 first stops to avoid approaching obstacles and then rotates toward \vec{O_{F}G} with

$${ω}_{f} = {k}_{o}^{d} sgn ( {α}_{f o}^{d} ) ,$$

where sgn is the sign function and

$${k}_{o}^{d}$$

is the parameter. When the follower 610 heads to \vec{O_{F}G}, it moves forward to leave D_{d}. Due to τ_{f}=0, the follower 610 can be regarded as a static obstacle by other agents like neighbouring robots and humans, and collisions can be avoided if these cooperative agents also execute obstacle avoidance strategies.

In the transition district Dₜ, the follower 610 is controlled based on both formation tracking and obstacle avoidance tasks, that is, the navigation control input is determined based on the desired obstacle avoidance direction \vec{O_{F}G} and the desired navigation direction \vec{O_{F}E}. In this regard, the desired navigation direction is determined based on desired pixel coordinates of the leader ground robot under the obstacle-free environment as described hereinbefore. In various example embodiments, the follower 610 is configured to move in a direction between \vec{O_{F}E} and \vec{O_{F}G} (inclusively) to balance these two tasks and decide on new desired pixel coordinates \hat{p}_{d}. The weights of two tasks may be determined by a weighting function φ(d_{fo}) satisfying: 1) monotonically non-increasing; 2) ∇d_{fo}∈ [symbol] , φ(d_{fo})∈[0, 1]; 3) φ(dₜ)=1 and φ(dₚ)=0, where d_{fo}∈[dₛ, dₜ). Accordingly, the new desired pixel coordinates for tracking the leader 650 is determined based on the desired obstacle avoidance direction \vec{O_{F}G}, the desired navigation direction \vec{O_{F}E} and a weighting function φ(d_{fo}) configured to output a weight value dependent on the closest obstacle distance d_{fo} for weighting the desired obstacle avoidance direction \vec{O_{F}G} and the desired navigation direction \vec{O_{F}E} depending on the closest obstacle distance d_{fo}. Accordingly, based on the weighting function φ(d_{fo}), when the follower 610 is in a safe area, the weighting function outputs a value of 1, thereby excluding the obstacle avoidance task. On the other hand, when the follower 610 is in a dangerous area or close to a dangerous area, the weighting function outputs a value of 0, thereby giving full weight to the obstacle avoidance task. When between the two, the function is between 0 and 1, and the robot balances between the two different tasks. For example, to eventually achieve both missions simultaneously, the environment is preferably spacious enough so that the direction of leader tracking

$${α}_{l f}^{d}$$

is also a direction of obstacle avoidance in the steady state and lasts long enough, as in Assumption 3. Otherwise, the follower 610 may prioritize obstacle avoidance over the formation tracking mission.

In addition, the control laws are continuous at the boundary d_{fo}=dₜ between Dₛ and Dₜ. In practical implementations, kₚ, k_{q}, and d_{q} may be increased to help the follower 610 complete obstacle avoidance in the transition district Dₜ. If the follower 610 cannot completely avoid obstacles in the transition district Dₜ,

$${k}_{o}^{d}$$

may be increased to help it leave the danger district D_{d} quickly and k may be increased to prevent it from returning to D_{d}.

### Simulation and Experimental Results

### Numerical Simulation Results

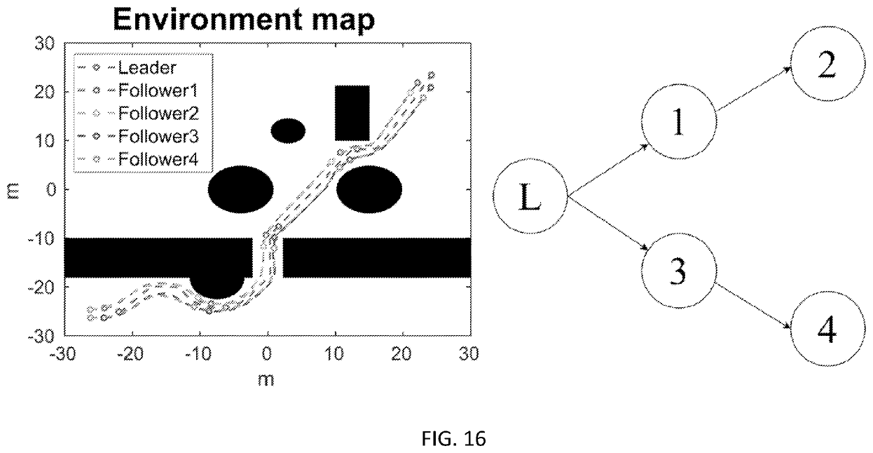

Several simulations were conducted. As shown in FIG. 16, a reference collision-free trajectory was generated for the leader robot and the follower robots was instructed to follow the leader. In this simulation, Follower 1 and 3 need to track Leader robot L, while Follower 2 and 4 are required to track Follower 1 and 3, respectively. Each follower robot is equipped with only one RGB-D camera, and it rotates the camera about an axis perpendicular to the ground to observe nearby obstacles and neighbouring robots. As shown in FIG. 16, each follower robot can follow its respective leader and successfully avoid collisions with obstacles and other robots.

The desired relative positions between each pair of leader-follower robots were set as

$${p}_{l 1}^{d} = {[ 2 , 1 ]}^{T} ( m ) , {p}_{l 3} = {[ 2 , - 1 ]}^{T} ( m ) , {p}_{12}^{d} = {[ 2 , 0 ]}^{T} ( m ) ,$$

$$and {p}_{34}^{d} = {[ 2 , 0 ]}^{T} ( m ) .$$

Due to Zₗ=0.5 m, the desired pixel coordinates were

$${C}_{l 1}^{d} = ( - 0 \text{.5} , - 0.25 ) , {C}_{l 3}^{d} = ( 0 \text{.5} , - 0.25 ) , {C}_{l 2}^{d} = ( 0 , - 0.25 ) , {C}_{34}^{d} = ( 0 , - 0.25 )$$

correspondingly. As for camera intrinsic parameters, u₀=320 pixels, v₀=240 pixels, αᵤ=αᵥ=500 pixels, uₘₐₓ=640 pixels, and vₘₐₓ=480 pixels. The control parameters were selected as kₚ=0.0045, k_{q}=0.001, γₚ=0.02, γ_{q}=0.04 for all followers. For obstacle avoidance, the parameters were

$${d}_{t} = 2 m , {d}_{s} = 0.5 m , {t}_{h} = 5 s , {θ}_{min} = - \frac{π}{2} ,$$

$${θ}_{max} = \frac{π}{2} , Δθ = \frac{π}{180} , k = 5 , and {θ}_{h} = \frac{π}{4} .$$

The parameters related to camera rotation are λ₁=0.4 to track the leader, λ₂=0.4 to explore the environment, λ₃=0.1 to track dynamic obstacles, and λ₄=0.1 to prevent large rotation. The units of all variables in the simulations and experiments are in accordance with the International System of Units, and Fᵢ represents Follower i.

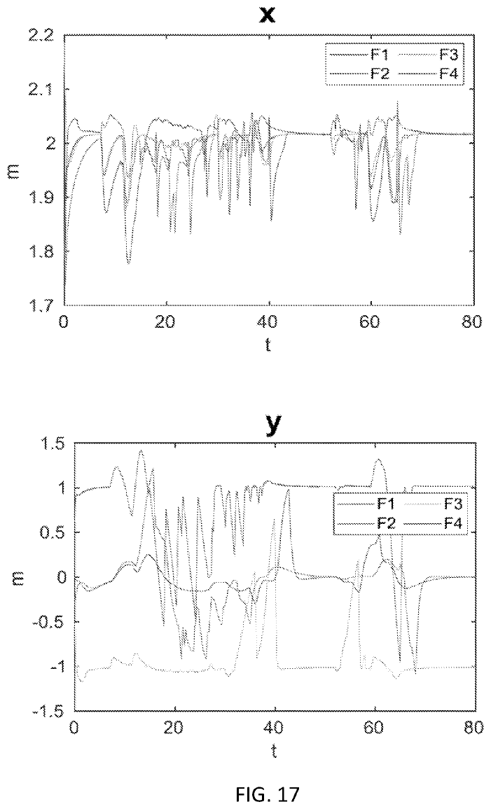

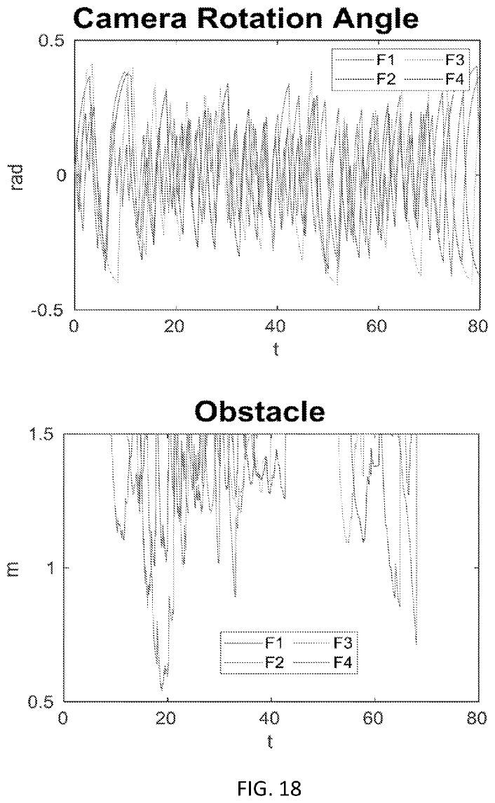

FIG. 17 shows that the relative positions between Follower i (namely, Follower 1 to 4, denoted as F1 to F4) and its leader eventually converge to the desired values in both x and y directions, indicating that the formation tracking was successfully achieved. Although these variables may occasionally deviate from the desired values due to avoiding obstacles, they can recover from the deviation when robots leave away from obstacles. As shown in FIG. 18, the followers explored the nearby obstacles and robots by repeatedly rotating their onboard camera, and were able to keep at least dₛ away from these obstacles.

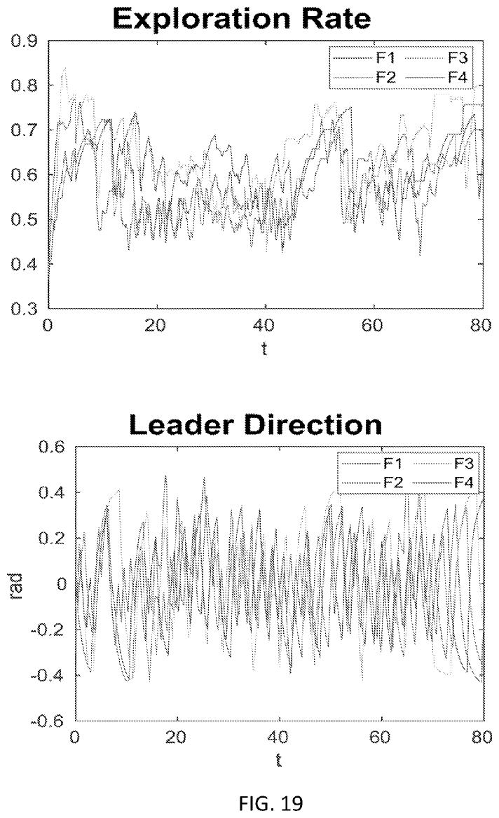

In FIG. 19, the exploration rate et of the nearby environment and the relative angle α_{lf} to the leader are depicted. Based on above parameters, the angle range of the camera is

$$[ atan ( \frac{- {u}_{0}}{{α}_{u}} ) , atan ( \frac{{u}_{max} - {u}_{0}}{{α}_{u}} ) ] \approx [ - 0.57 , 0.57 ] .$$

Without camera rotation, the rate eᵢ is only about

$$\frac{0.57 \times 2}{{θ}_{max} - {θ}_{min}} = 36 \% .$$

Without the camera rotation device and corresponding method according to various example embodiments of the present invention, eᵢ can reach an average of about 60%. As for the leader tracking, the relative angles are within the angle range generated by camera FOV most of the time. For example, the corresponding weights can be adjusted to balance these tasks and get better results.

### Experimental Results

The results of the formation experiments will now be presented. The formation experiments were performed using two Pioneer 3-AT robots in a pair of leader-follower configuration. Without loss of generality, a collision-free path was inputted to the leader robot. For feedback of the surrounding environment, the follower robot was only equipped with the rotatable RGB-D camera as described herein according to various example embodiments. The follower robot was tested for accomplishing leader tracking, visibility maintenance, obstacle detection, and avoidance. There were two experiments conducted to demonstrate the performance of avoiding static obstacles and dynamic obstacles for the robot formation, respectively.

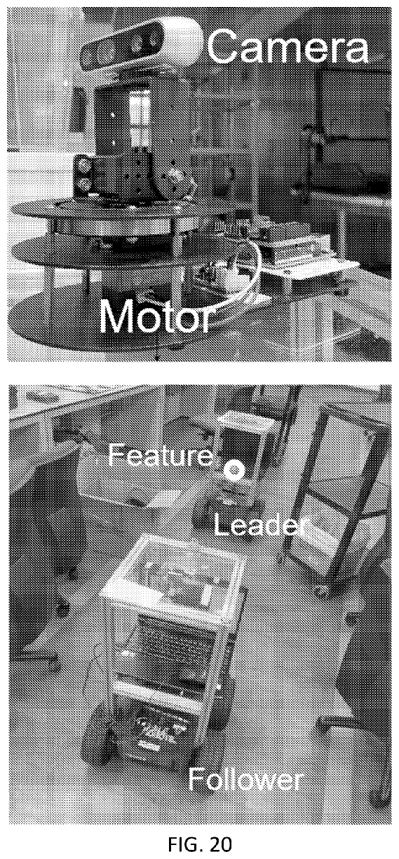

The robot formation during the first experiment is illustrated at the bottom side of FIG. 20, including a leader robot and a follower. The follower detects the feature (e.g., a green ball) on the leader with a rotatable Realsense D435 camera shown in the right. The robots, which have a width of 0.5 m, were tested to operate in an extremely challenging obstacle environment, where the narrowest width was only 0.8 m. For the experiments, the intrinsic parameters of camera were αᵤ=608.7 pixels, αᵥ=608.9 pixels, u₀=315.7 pixels, v₀=233.7 pixels, uₘₐₓ=640 pixels, and vₘₐₓ=480 pixels. As for control parameters, they included kₚ=0.002, k_{q}=0.004, γₚ=0.005, γ_{q}=0.005. For obstacle avoidance, the parameters were set as

$${θ}_{min} = - \frac{π}{2} , {θ}_{max} = \frac{π}{2} , {d}_{s} = 0.3 m , {d}_{t} = 0.95 m , Δθ = \frac{π}{180} , k = 5 .$$

The weights related to camera rotation were λ₁=0.5, λ₂=0.4, λ₄=0.1. The desired pixel coordinates are p_{d}=0 and q_{d}=0.033, corresponding to x_{d}=1.1 m and y_{d}=0 m in the experiments.

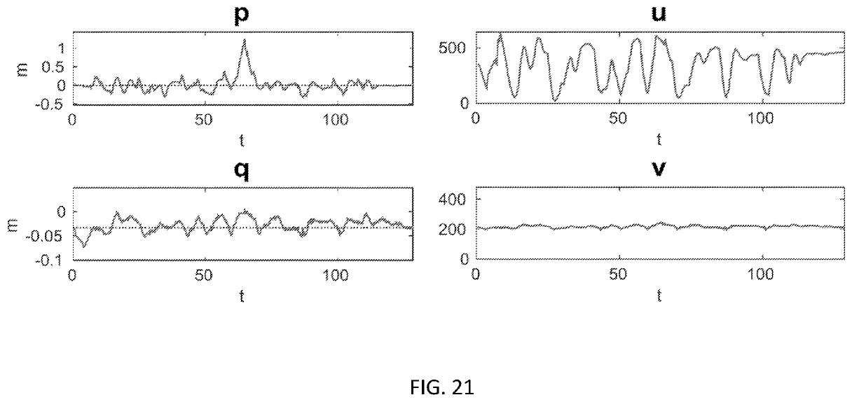

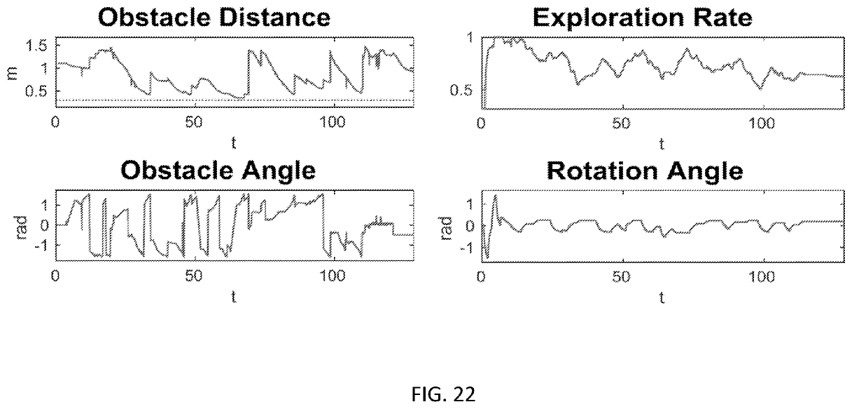

FIG. 21 shows that the normalized pixel coordinates of the feature eventually converge to the desired values, indicating successful formation tracking. Moreover, the pixel values (u, v) of the feature mostly stay within the image plane, which can be adjusted using the camera rotation parameters λ. FIG. 22 illustrates the follower's relative distance and angle to the nearest obstacle. It is observed that the follower maintained a safe distance of dₛ away from the obstacles and steered in the direction away from them (i.e., the absolute value of the obstacle angle approaches π/2). The exploration rate eᵢ was initially about 32.3% without camera rotation, but with the camera rotation method according to various example embodiments, it increases to over 60% on average. The camera first rotated around to obtain an initial view of the environment and then reciprocated around 0 (i.e., camera rotation angle of 0, which means no camera rotation) to accomplish multiple tasks, such as exploration and leader tracking. Using the rotating camera method according to various example embodiments, the robot achieved obstacle avoidance and leader tracking simultaneously while performing vision-based formation tracking.

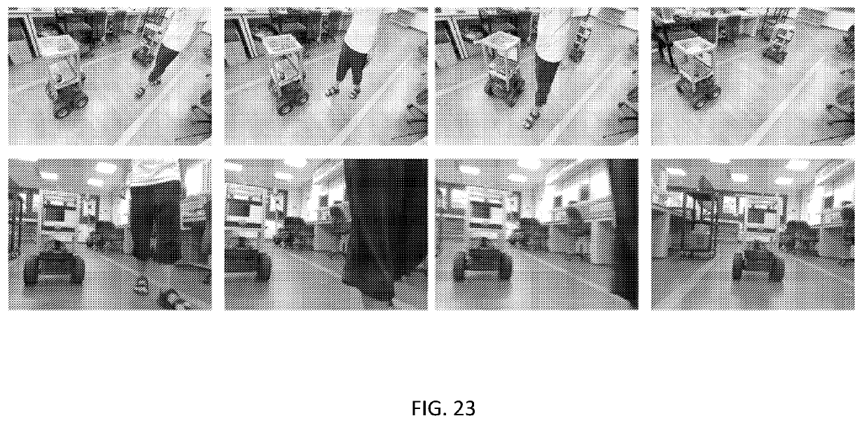

The second experiment involved avoiding moving obstacles, such as humans, where the moving obstacles were detected by ray-casting methods. As in FIG. 23, the follower attempted to avoid possible collisions during formation tracking. When the follower detected a human, it rotated its camera to track the human as in the first and second groups of photos, which can be adjusted by the parameter λ₃. After the follower has established a view of the human obstacle, it rotates away from the human to ensure safety, as illustrated in the third photo. However, during the obstacle avoidance maneuver, the leader may move out of the follower's FOV. To address this issue, the follower's camera rotates back to track the leader until the human moves away, as shown in the last photo in FIG. 23. Accordingly, this approach allows the follower to achieve both obstacle avoidance and leader tracking objectives simultaneously.

In various example embodiments, there is provided a method of vision-based leader-follower formation control for nonholonomic mobile robots under obstacle-free environments without communication devices. Each follower robot is equipped with an RGB-D camera with a limited FOV, and the leader robot can be tracked and always remain in the FOV of the follower camera using the method.

In various example embodiments, there is provided a method of rotation for the follower onboard RGB-D camera to achieve the detection of the leader and nearby obstacles with only a limited FOV. To better accomplish the detection tasks, the rotation angle of the camera is decided by considering the detection of the leader and static obstacles, avoidance of large turns and tracking the dynamic obstacles.

In various example embodiments, there is provided a method of constructing a scene point set (including nearby obstacles) with the visual feedback from the rotating camera. In particular, the static obstacles are added to the set by continuously fusing the static obstacle data at the previous moment with the observations of the static obstacles at the current moment, while the dynamic obstacles are added directly to the set.

In various example embodiments, there is provided a method of obstacle avoidance for the follower robot in the formation based on the controller in the first aspect and the scene point set in the third aspect. When the robot comes across obstacles, it executes the control method to achieve collision avoidance with both static and dynamic obstacles, and formation tracking with the leader, using the detection results from the onboard rotating camera.

In various example embodiments, there is provided a formation control method for multiple mobile robots in the leader-follower configuration in the obstacle environment using only RGB-D cameras, which can overcome negative effects caused by the camera limited FOV and achieve formation tracking and obstacle avoidance simultaneously without inter-robot communication and previously known environment maps.

In various example embodiments, a camera rotation algorithm is proposed for the follower onboard camera to achieve the detection and tracking of the leader, nearby environment and dynamic obstacles using only RGB-D camera with the limited FOV.

In various example embodiments, for the camera rotation algorithm, the follower camera performs the rotation operation by designing several potential functions to enable tracking of leaders and dynamic obstacles, exploration of undetected environments and avoidance of sharp turns.

In various example embodiments, for the camera rotation algorithm, the entire nearby undetected area is defined as an area that has not been updated for a long time and divided into two parts, including the left and the right, and wherein the camera tends to rotate towards the side with more undetected areas.

In various example embodiments, the set of nearby obstacles is constructed based on current and historical colour and depth images.

In various example embodiments, there is provided a method of constructing a scene point set, whereby the scene point set is generated by considering static obstacles and dynamic obstacles separately, the static obstacle areas are constructed by combining the current image and historical images, and the dynamic obstacles are added directly to the scene point set.

In various example embodiments, for the method of constructing the scene point set, the distance to the nearest obstacle is calculated and the workspace of the follower robot is divided into three different parts based on the obstacle distance, including safe region, transition region and dangerous region.

In various example embodiments, an image-based controller is designed for the follower robot that enables it to track the leader and maintain the leader within the limited FOV in the obstacle-free environment.

In various example embodiments, the follower robot calculates the available area by performing an erosion operation on the set of obstacles constructed and the degree of erosion can be adjusted.

In various example embodiments, the obstacle avoidance direction is selected as the direction closest to the desired relative angle to the leader within the available set determined.

In various example embodiments, the follower robot determines the final motion direction by balancing obstacle avoidance and leader tracking missions based on the potential function configured for the transition region, and the potential function increases as the obstacle distance decreases.

In various example embodiments, the follower robot stops to avoid colliding with obstacles in the danger region and rotates toward obstacle avoidance direction until heading it, and then the follower moves forward to leave obstacles.

Accordingly, leader-following formation tracking control in an obstacle environment is advantageously achieved using only one rotatable RGB-D camera for feedback of the surrounding environment. The camera rotation method enables the follower robot to perceive nearby obstacles and track the leader with a limited FOV camera simultaneously. By leveraging the camera feedback, the multi-objective controller according to various example embodiments can concurrently achieve obstacle avoidance, leader tracking, and visibility maintenance.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of controlling a follower ground robot for tracking a leader ground robot as a leader-follower pair, the follower ground robot comprising a mobile platform configured to travel on a ground and a depth sensor configured to be rotatable with respect to the mobile platform for rotating a sensing direction, the method comprising:
obtaining a current color image and associated depth information of a scene captured by the depth sensor;
determining a scene point set based on the current color image and the associated depth information, the scene point set comprising a plurality of scene points, each scene point corresponding to a pixel point of the current color image and has associated therewith a relative distance and a relative angle between the follower ground robot and a scene portion at the pixel point of the current color image;
obtaining pixel coordinates of the leader ground robot in the current color image;
determining a sensing direction control input for controlling, by rotating the depth sensor, a sensing direction of the depth sensor based on the scene point set;
determining a navigation control input for controlling a movement of the mobile platform based on the pixel coordinates of the leader ground robot and the scene point set; and
controlling the sensing direction of the depth sensor and the movement of the mobile platform based on the sensing direction control input and the navigation control input, respectively, for tracking the leader ground robot and maintaining the leader ground robot within a field of view of the depth sensor.

2. The method according to claim 1, wherein said determining the scene point set comprises, for each pixel point of the current color image:
determining a corresponding position of the scene portion at the pixel point in a current frame of the follower ground robot based on the depth information associated with the pixel point of the current colour image; and
adding a scene point in the scene point set corresponding to the position of the scene portion at the pixel point in the current frame of the follower ground robot, the scene point having associated therewith the relative distance and the relative angle between the follower ground robot and the scene portion at the pixel point of the current color image.

3. The method according to claim 1, wherein
the sensor direction control input is determined based on a leader tracking factor function and an area exploration factor function,
the leader tracking factor function configured to output a leader tracking factor value dependent on a sensor direction variable, the leader tracking factor value providing a measure of tracking of the leader ground robot with respect to the field of view of the depth sensor for a sensor direction, and
the area exploration factor function configured to output an area exploration factor value dependent on the sensor direction variable, the area exploration factor value providing a measure of a degree of sensor obstacle exploration of an area associated with a sensor direction.

4. The method according to claim 3, wherein
the sensor direction control input is determined further based on a dynamic obstacle tracking factor function and a large sensor rotation avoidance factor function,
the dynamic obstacle tracking factor function configured to output a dynamic obstacle tracking factor value dependent on the sensor direction variable, the dynamic obstacle tracking factor value providing a measure of tracking of one or more moving obstacles with respect to the field of view of the depth sensor for a sensor direction, and
the large sensor rotation avoidance factor function configured to output a large sensor rotation avoidance factor value dependent on the sensor direction variable, the large sensor rotation avoidance factor value providing a measure of a degree of sensor rotation for a sensor direction.

5. (canceled)

6. The method according to claim 1, wherein said determining the navigation control input for controlling a movement of the mobile platform comprises:
determining a closest obstacle distance between the follower ground robot and a closest scene portion thereto based on the scene point set;
determining an obstacle safety level of the follower ground robot based on the closest obstacle distance; and
determining the navigation control input based on the obstacle safety level of the follower ground robot.

7. The method according to claim 6, wherein the obstacle safety level comprises a danger level determined based on the closest obstacle distance with respect to a danger level threshold, a safe level determined based on the closest obstacle distance with respect to a safe level threshold and a transition level determined based on the danger level threshold and the safe level threshold.

8. The method according to claim 7, further comprising determining an available navigation direction set for obstacle avoidance based on the scene point set, wherein, based on determining that the obstacle safety level of the follower ground robot is at the transition level, the navigation control input is determined based on a desired obstacle avoidance direction and a desired navigation direction, wherein the desired obstacle avoidance direction is determined based on the available navigation direction set and the desired navigation direction is determined based on desired pixel coordinates of the leader ground robot for maintaining the leader ground robot within the field of view of the depth sensor.

9. The method according to claim 8, wherein the desired obstacle avoidance direction is determined based on an available navigation direction in the available navigation direction set that is the same as or closest to the desired navigation direction.

10. The method according to claim 9, wherein the available navigation direction set comprises available navigation directions determined based on scene points in the scene point set which have associated therewith the relative distance between the follower ground robot and the scene portion satisfying a predetermined distance threshold condition.

11. The method according to claim 8, wherein said determining the navigation control input comprises:
determining new desired pixel coordinates for the leader ground robot based on the desired obstacle avoidance direction, the desired navigation direction and a weighting function configured to output a weight value dependent on the closest obstacle distance for weighting the desired obstacle avoidance direction and the desired navigation direction depending on the closest obstacle distance; and
determining the navigation control input based on the pixel coordinates of the leader ground robot and the new desired pixel coordinates for leader ground robot.

12-13. (canceled)

14. A control system for controlling a follower ground robot for tracking a leader ground robot as a leader-follower pair, the follower ground robot comprising a mobile platform configured to travel on a ground and a depth sensor configured to be rotatable with respect to the mobile platform for rotating a sensing direction, the control system comprising:
at least one memory; and
at least one processor communicatively coupled to the at least one memory and configured to:
obtain a current color image and associated depth information of a scene captured by the depth sensor;
determine a scene point set based on the current color image and the associated depth information, the scene point set comprising a plurality of scene points, each scene point corresponding to a pixel point of the current color image and has associated therewith a relative distance and a relative angle between the follower ground robot and a scene portion at the pixel point of the current color image;
obtain pixel coordinates of the leader ground robot in the current color image;
determine a sensing direction control input for controlling, by rotating the depth sensor, a sensing direction of the depth sensor based on the scene point set;
determine a navigation control input for controlling a movement of the mobile platform based on the pixel coordinates of the leader ground robot and the scene point set; and
control the sensing direction of the depth sensor and the movement of the mobile platform based on the sensing direction control input and the navigation control input, respectively, for tracking the leader ground robot and maintaining the leader ground robot within a field of view of the depth sensor.

15. The control system according to claim 14, wherein said determine the scene point set comprises, for each pixel point of the current color image:
determining a corresponding position of the scene portion at the pixel point in a current frame of the follower ground robot based on the depth information associated with the pixel point of the current colour image; and
adding a scene point in the scene point set corresponding to the position of the scene portion at the pixel point in the current frame of the follower ground robot, the scene point having associated therewith the relative distance and the relative angle between the follower ground robot and the scene portion at the pixel point of the current color image.

16. The control system according to claim 14, wherein
the sensor direction control input is determined based on a leader tracking factor function and an area exploration factor function,
the leader tracking factor function configured to output a leader tracking factor value dependent on a sensor direction variable, the leader tracking factor value providing a measure of tracking of the leader ground robot with respect to the field of view of the depth sensor for a sensor direction, and
the area exploration factor function configured to output an area exploration factor value dependent on the sensor direction variable, the area exploration factor value providing a measure of a degree of sensor obstacle exploration of an area associated with a sensor direction.

17. The control system according to claim 16, wherein
the sensor direction control input is determined further based on a dynamic obstacle tracking factor function and a large sensor rotation avoidance factor function,
the dynamic obstacle tracking factor function configured to output a dynamic obstacle tracking factor value dependent on the sensor direction variable, the dynamic obstacle tracking factor value providing a measure of tracking of one or more moving obstacles with respect to the field of view of the depth sensor for a sensor direction, and
the large sensor rotation avoidance factor function configured to output a large sensor rotation avoidance factor value dependent on the sensor direction variable, the large sensor rotation avoidance factor value providing a measure of a degree of sensor rotation for a sensor direction.

18. (canceled)

19. The control system according to claim 14, wherein said determine the navigation control input for controlling a movement of the mobile platform comprises:
determining a closest obstacle distance between the follower ground robot and a closest scene portion thereto based on the scene point set;
determining an obstacle safety level of the follower ground robot based on the closest obstacle distance; and
determining the navigation control input based on the obstacle safety level of the follower ground robot.

20. The control system according to claim 19, wherein the obstacle safety level comprises a danger level determined based on the closest obstacle distance with respect to a danger level threshold, a safe level determined based on the closest obstacle distance with respect to a safe level threshold and a transition level determined based on the danger level threshold and the safe level threshold.

21. The control system according to claim 20, wherein the at least one processor is further configured to determine an available navigation direction set for obstacle avoidance based on the scene point set, wherein, based on determining that the obstacle safety level of the follower ground robot is at the transition level, the navigation control input is determined based on a desired obstacle avoidance direction and a desired navigation direction, wherein the desired obstacle avoidance direction is determined based on the available navigation direction set and the desired navigation direction is determined based on desired pixel coordinates of the leader ground robot for maintaining the leader ground robot within the field of view of the depth sensor.

22. The control system according to claim 21, wherein the desired obstacle avoidance direction is determined based on an available navigation direction in the available navigation direction set that is the same as or closest to the desired navigation direction.

23. The control system according to claim 22, wherein the available navigation direction set comprises available navigation directions determined based on scene points in the scene point set which have associated therewith the relative distance between the follower ground robot and the scene portion satisfying a predetermined distance threshold condition.

24. The control system according to claim 21, wherein said determine the navigation control input comprises:
determining new desired pixel coordinates for tracking the leader ground robot based on the desired obstacle avoidance direction, the desired navigation direction and a weighting function configured to output a weight value dependent on the closest obstacle distance for weighting the desired obstacle avoidance direction and the desired navigation direction depending on the closest obstacle distance; and
determining the navigation control input based on the pixel coordinates of the leader ground robot and the new desired pixel coordinates for leader ground robot.

25-27. (canceled)

28. A mobile ground robot comprising:
a mobile platform configured to travel on a ground;
a depth sensor configured to be rotatable with respect to the mobile platform for rotating a sensing direction; and
the control system according to claim 14 communicatively coupled to the mobile platform and the depth sensor for controlling the mobile ground robot as a follower ground robot for tracking a leader ground robot as a leader-follower pair.
